(19) United States
(12) Patent Application Publication
(10) Pub. No.: US 2019/0394300 A1
(43) Pub. Date: Dec. 26, 2019

(54) Methods, Systems, and Computer Program Products for Accessing a Service Via a Proxy Communications Agent

(71) Applicant: SITTING MAN, LLC, Madison, GA (US)

(72) Inventor: Robert Paul Morris, Madison, GA (US)

(21) Appl. No.: 16/560,983

(22) Filed: Sep. 4, 2019

Related U.S. Application Data
(63) Continuation-in-part of application No. 15/800,033, filed on Oct. 31, 2017.
Application No. 15/800,033 is a continuation-in-part of application No. 14/274,623, filed on May 9, 2014, now abandoned.
Application No. 14/274,623 is a continuation-in-part of application No. 13/647,144, filed on Oct. 8, 2012, now abandoned.
Application No. 13/647,144 is a continuation-in-part of application No. 13/624,940, filed on Sep. 23, 2012, now abandoned.
Application No. 13/624,940 is a continuation-in-part of application No. 13/716,160, filed on Dec. 16, 2012, now abandoned.
Application No. 13/716,160 is a continuation of application No. 13/716,158, filed on Dec. 16, 2012, now abandoned.

(51) Int. Cl. H04L 29/08

(52) U.S. Cl. CPC H04L 67/32

(57) ABSTRACT

Methods and systems are described for accessing a service via a proxy communications agent. In an aspect, request information for identifying a service request is identified by a first communications agent in a first execution environment. A communications request, based on the request information, is sent by the first communications agent to a second communications agent to send to the service request to a service application. A communications response is received by the first execution environment based on a service response generated by the service application in processing the service request. In another aspect, a communications request is received by a communications agent, representing a user, from a first communications agent. Access information is identified based on the user. A service request with the access information, based on the communications request, is sent to a service application.

### RELATED APPLICATIONS

The present application is a continuation-in-part of and claims priority to U.S. patent application No. Ser. No. 15/800,033 (DR0149B) filed Oct. 31, 2017 and entitled “METHODS, SYSTEMS, AND COMPUTER PROGRAM PRODUCTS FOR PROCESSING A DATA OBJECT IDENTIFICATION REQUEST IN A COMMUNICATION,” which, in turn, is a continuation-in-part of and claims priority to U.S. patent application Ser. No. 14/274,623 (DR0149-CIP) filed May 9, 2014 and entitled “METHODS, SYSTEMS, AND PROGRAM PRODUCTS FOR PROCESSING A DATA OBJECT IDENTIFICATION REQUEST IN A COMMUNICATION,” which, in turn, is a continuation-in-part of and claims priority to U.S. application Ser. No. 13/647,144 (DR0254) filed Oct. 8, 2012 and entitled “METHODS, SYSTEMS, AND PROGRAM PRODUCTS FOR EXCHANGING PRESENTATION DATA BASED ON A COMMUNICATION,” U.S. application Ser. No. 13/624,940 (DR0265) filed Sep. 23, 2012 and entitled “METHODS, SYSTEMS, AND PROGRAM PRODUCTS FOR PROCESSING A REFERENCE IN A COMMUNICATION TO A REMOTE DATA OBJECT,” U.S. application Ser. No. 13/716,160 (DR0275) filed Dec. 16, 2012 and entitled “METHODS, SYSTEMS, AND COMPUTER PROGRAM PRODUCTS FOR ACCESSING A SERVICE VIA A PROXY COMMUNICATIONS AGENT,” and U.S. application Ser. No. 13/716,158 (DR0291) filed Dec. 16, 2012 and entitled “METHODS, SYSTEMS, AND COMPUTER PROGRAM PRODUCTS FOR PROCESSING A REQUEST VIA A COMMUNICATIONS AGENT”.

This application is related to the following commonly owned U.S. patent application: U.S. application Ser. No. 13/647,144 (DR0254) filed Oct. 8, 2012 and entitled “METHODS, SYSTEMS, AND PROGRAM PRODUCTS FOR EXCHANGING PRESENTATION DATA BASED ON A COMMUNICATION;” U.S. application Ser. No. 13/624,940 (DR0265) filed Sep. 23, 2012 and entitled “METHODS, SYSTEMS, AND PROGRAM PRODUCTS FOR PROCESSING A REFERENCE IN A COMMUNICATION TO A REMOTE DATA OBJECT;” U.S. application Ser. No. 13/716,160 (DR0275) filed Dec. 16, 2012 and entitled “METHODS, SYSTEMS, AND COMPUTER PROGRAM PRODUCTS FOR ACCESSING A SERVICE VIA A PROXY COMMUNICATIONS AGENT;” U.S. application Ser. No. 13/716,158 (DR0291) filed Dec. 16, 2012 and entitled “METHODS, SYSTEMS, AND COMPUTER PROGRAM PRODUCTS FOR PROCESSING A REQUEST VIA A COMMUNICATIONS AGENT;” and U.S. application Ser. No. 12/833,016 (PMOR0158) filed on 2010 Jul. 9, entitled “METHODS, SYSTEMS, AND PROGRAM PRODUCTS FOR REFERENCING AN ATTACHMENT IN A COMMUNICATION”, the entire contents of each which are herein incorporated by reference for all purposes.

### BACKGROUND

For any given user, many files, web pages, applications, services, and other resources on a network, such as the Internet and various intranets, are available only through others users. Additionally, for any given user accessing these resources requires exchanging one or more communications with another user. Sometimes this requires asking the other user through a written and/or spoken message to interact with a computing device to access a resource. Communications agents such as email, instant message, and voice clients are a primary means by which users exchange information and access resources that are otherwise inaccessible or difficult to access.

Accordingly, there exists a need for methods, systems, and computer program products for accessing a service via a proxy communications agent.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods and systems are described for accessing a service via a proxy communications agent. In one aspect, a method includes receiving, via interaction with a first user by a first communications agent in a first execution environment, request information for identifying a first service request. The method further includes sending, in a communication via a network by the first communications agent to a second communications agent in a second execution environment representing a second user, a communications request based on the request information. The method still further includes receiving, via the network by the first execution environment in response to sending the communications request, a communications response based on a first service response generated by a first service application included in processing the first service request.

Also, a system for accessing a service via a proxy communications agent is described that includes at least one processor; and logic encoded in at least one data storage media for execution by the at least one processor that when executed is operable for and/or otherwise included in receiving, via interaction with a first user by a first communications agent in a first execution environment, request information for identifying a first service request; sending, in a communication via a network by the first communications agent to a second communications agent in a second execution environment representing a second user, a communications request based on the request information; and receiving, via the network by the first execution environment in response to sending the communications request, a communications response based on a first service response generated by a first service application included in processing the first service request;

Further, a system for accessing a service via a proxy communications agent is described. The system includes a processor that executes an instruction included in at least one of a request agent component, a com-out component, and a response director component during operation of the system. During operation of the system the request agent component is operable for and/or otherwise included in receiving, via interaction with a first user by a first communications agent in a first execution environment, request information for identifying a first service request; the com-out component is operable for and/or otherwise included in sending, in a communication via a network by the first communications agent to a second communications agent in a second execution environment representing a second user, a communications request based on the request information; and the response director component is operable for and/or otherwise included in receiving, via the network by the first execution environment in response to sending the communications request, a communications response based on a first service response generated by a first service application included in processing the first service request.

In another aspect of the methods and systems described for accessing a service via a proxy communications agent, a method includes receiving, via a network by a second communications agent representing a second user and operating in a second execution environment from a first communications agent representing a first user and operating in a first execution environment, a communications request. The method further includes identifying access information, by the second communications agent based on the second user. The method still further includes sending, via a network by the second execution environment in processing the communications request, a first service request along with the access information to a first service application.

Also, a system for accessing a service via a proxy communications agent is described that includes at least one processor; and logic encoded in at least one data storage media for execution by the at least one processor that when executed is operable for and/or otherwise included in receiving, via a network by a second communications agent representing a second user and operating in a second execution environment from a first communications agent representing a first user and operating in a first execution environment, a communications request; identifying access information, by the second communications agent based on the second user; and sending, via a network by the second execution environment in processing the communications request, a first service request along with the access information to a first service application.

Further, a system for accessing a service via a proxy communications agent is described. The system includes a processor that executes an instruction included in at least one of a request-in component, an access proxy component, and a request gateway component during operation of the system. During operation of the system the request-in component is operable for and/or otherwise included in receiving, via a network by a second communications agent representing a second user and operating in a second execution environment from a first communications agent representing a first user and operating in a first execution environment, a communications request; the access proxy component is operable for and/or otherwise included in identifying access information, by the second communications agent based on the second user; and the request gateway component is operable for and/or otherwise included in sending, via a network by the second execution environment in processing the communications request, a first service request along with the access information to a first service application.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary execution environment in which the subject matter may be implemented that includes and/or otherwise is provided by a hardware device;

FIG. 2A is a flow diagram illustrating a method for accessing a service via a proxy communications agent according to an aspect of the subject matter described herein;

FIG. 2B is a flow diagram illustrating a method for accessing a service via a proxy communications agent according to an aspect of the subject matter described herein;

FIG. 3A is a block diagram illustrating an arrangement of components for accessing a service via a proxy communications agent according to another aspect of the subject matter described herein;

FIG. 3B is a block diagram illustrating an arrangement of components for accessing a service via a proxy communications agent according to another aspect of the subject matter described herein;

FIG. 4A is a block diagram illustrating an arrangement of components for accessing a service via a proxy communications agent according to another aspect of the subject matter described herein;

FIG. 4B is a block diagram illustrating an arrangement of components for accessing a service via a proxy communications agent according to another aspect of the subject matter described herein;

FIG. 4C is a block diagram illustrating an arrangement of components for accessing a service via a proxy communications agent according to another aspect of the subject matter described herein;

FIG. 5 is a network diagram illustrating a system for accessing a service via a proxy communications agent according to another aspect of the subject matter described herein;

FIG. 6A is a diagram illustrating a user interface presented via a display according to another aspect of the subject matter described herein;

FIG. 6B is a diagram illustrating a user interface presented via a display according to another aspect of the subject matter described herein;

FIG. 6C is a diagram illustrating a user interface presented via a display according to another aspect of the subject matter described herein;

FIG. 7 is a message flow diagram illustrating an exemplary data and execution flow for accessing a service via a proxy communications agent according to an aspect of the subject matter described herein;

FIG. 8A illustrates an exemplary portion of a communication according to an aspect of the subject matter described herein;

FIG. 8B illustrates another exemplary portion of a communication according to an aspect of the subject matter described herein; and

FIG. 8C illustrates another exemplary portion of a communication according to an aspect of the subject matter described herein.

### DETAILED DESCRIPTION

One or more aspects of the disclosure are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of the disclosure. It may be evident, however, to one skilled in the art, that one or more aspects of the disclosure may be practiced with a lesser degree of these specific details. In other instances, well-known structures and devices are shown in block diagram form in order to facilitate describing one or more aspects of the disclosure. It is to be understood that other embodiments and/or aspects may be utilized and structural and functional modifications may be made without departing from the scope of the subject matter disclosed herein.

The use of “including”, “comprising”, “having”, and variations thereof are meant to encompass the items listed thereafter and equivalents thereof as well as additional items and equivalents thereof. Terms used to describe interoperation and/or coupling between components are intended to include both direct and indirect interoperation and/or coupling, unless otherwise indicated. Exemplary terms used in describing interoperation and/or coupling include “mounted,” “connected,” “attached,” “coupled,” “communicatively coupled,” “operatively coupled,” “invoked”, “called”, “provided”, “received”, “identified”, “interoperated” and similar terms and their variants.

As used herein, any reference to an entity “in” an association is equivalent to describing the object as “identified” by the association, unless explicitly indicated otherwise.

Unless otherwise defined, all technical and scientific terms used herein have the same meaning as commonly understood by one of ordinary skill in the art to which this disclosure belongs. Although methods, components, and devices similar or equivalent to those described herein can be used in the practice or testing of the subject matter described herein, suitable methods, components, and devices are described below.

All publications, patent applications, patents, and other references mentioned herein are incorporated by reference in their entirety. In case of conflict, the present disclosure, including definitions, will control. In addition, the materials, methods, and examples are illustrative only and not intended to be limiting.

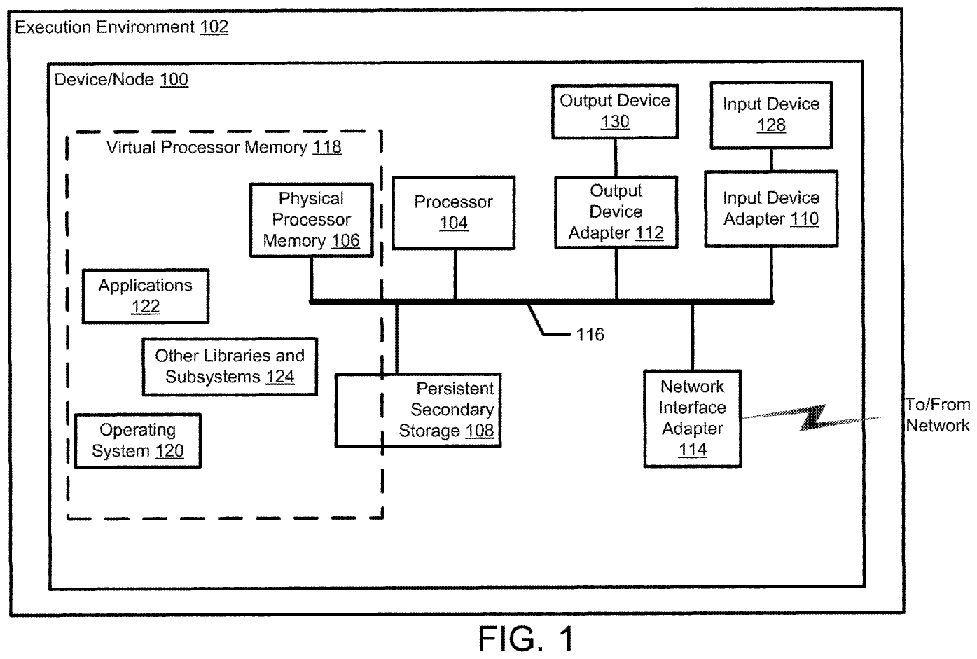

An exemplary device included in an execution environment that may be programmed, adapted, modified, and/or otherwise configured according to the subject matter is illustrated in FIG. 1. An “execution environment”, as used herein, is an arrangement of hardware and, in some aspects, software that may be further modified, transformed, and/or otherwise configured to include and/or otherwise host an arrangement of components to perform a method of the subject matter described herein. An execution environment includes and/or is otherwise provided by one or more devices. The execution environment is said to be the execution environment “of” the device and/or devices. An execution environment may be and/or may include a virtual execution environment including software components operating in a host execution environment. Exemplary devices included in and/or otherwise providing suitable execution environments that may be adapted, programmed, and/or otherwise modified according to the subject matter include a workstation, a desktop computer, a laptop or notebook computer, a server, a handheld computer, a mobile telephone or other portable telecommunication device, a media playing device, a gaming system, a tablet computer, a portable electronic device, a handheld electronic device, a multiprocessor device, a distributed system, a consumer electronic device, a router, a network server, or any other type and/or form of computing, telecommunications or media device that is suitable to perform the subject matter described herein. Those skilled in the art will understand that the components illustrated in FIG. 1 are exemplary and may vary by particular execution environment.

FIG. 1 illustrates a hardware device 100 included in an execution environment 102. FIG. 1 illustrates that execution environment 102 includes a processor 104, such as one or more microprocessors; a physical processor memory 106 including storage locations identified by addresses in a physical memory address space of processor 104; a persistent secondary storage 108, such as one or more hard drives and/or flash storage media; an input device adapter 110, such as a key or keypad hardware, a keyboard adapter, and/or a mouse adapter; an output device adapter 112, such as a display and/or an audio adapter to present information to a user; a network interface component, illustrated by a network interface adapter 114, to communicate via a network such as a LAN and/or WAN; and a mechanism that operatively couples elements 104-114, illustrated as a bus 116. Elements 104-114 may be operatively coupled by various means. Bus 116 may comprise any type of bus architecture, including a memory bus, a peripheral bus, a local bus, and/or a switching fabric.

As used herein a “processor” is an instruction execution machine, apparatus, or device. A processor may include one or more electrical, optical, and/or mechanical components that operate in interpreting and executing program instructions. Exemplary processors include one or more microprocessors, digital signal processors (DSPs), graphics processing units, application-specific integrated circuits (ASICs), optical or photonic processors, and/or field programmable gate arrays (FPGAs). Processor 104 may access instructions and data via one or more memory address spaces in addition to the physical memory address space. A memory address space includes addresses identifying locations in a processor memory. The addresses in a memory address space are included in defining a processor memory. Processor 104 may have more than one processor memory. Thus, processor 104 may have more than one memory address space. Processor 104 may access a location in a processor memory by processing an address identifying the location. The processed address may be identified by an operand of an instruction and/or may be identified by a register and/or other portion of processor 104.

FIG. 1 illustrates a virtual processor memory 118 spanning at least part of physical processor memory 106 and may span at least part of persistent secondary storage 108. Virtual memory addresses in a memory address space may be mapped to physical memory addresses identifying locations in physical processor memory 106. An address space including addresses that identify locations in a virtual processor memory is referred to as a “virtual memory address space”; its addresses are referred to as “virtual memory addresses”; and its processor memory is referred to as a “virtual processor memory” or “virtual memory”. The term “processor memory” may refer to physical processor memory, such as processor memory 106, and/or may refer to virtual processor memory, such as virtual processor memory 118, depending on the context in which the term is used.

Physical processor memory 106 may include various types of memory technologies. Exemplary memory technologies include static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC 100 SDRAM, Double Data Rate SDRAM (DDR SDRAM), Enhanced SDRAM (ESDRAM), SyncLink DRAM (SLDRAM), Ferroelectric RAM (FRAM), RAMBUS DRAM (RDRAM) Direct DRAM (DRDRAM), and/or XDR™ DRAM. Physical processor memory 106 may include volatile memory as illustrated in the previous sentence and/or may include non-volatile memory such as non-volatile flash RAM (NVRAM) and/or ROM.

Persistent secondary storage 108 may include one or more flash memory storage devices, one or more hard disk drives, one or more magnetic disk drives, and/or one or more optical disk drives. Persistent secondary storage may include a removable data storage medium. The drives and their associated computer readable media provide volatile and/or nonvolatile storage for computer-executable instructions, data structures, program components, and other data.

Execution environment 102 may include software components stored in persistent secondary storage 108, in remote storage accessible via a network, and/or in a processor memory. FIG. 1 illustrates execution environment 102 including an operating system 120, one or more applications 122, and other program code and/or data components illustrated by other libraries and subsystems 124. In an aspect, some or all software components may be stored in locations accessible to processor 104 in a shared memory address space shared by the software components. The software components accessed via the shared memory address space may be stored in a shared processor memory defined by the shared memory address space. In another aspect, a first software component may be stored in one or more locations accessed by processor 104 in a first address space and a second software component may be stored in one or more locations accessed by processor 104 in a second address space. The first software component is stored in a first processor memory defined by the first address space and the second software component is stored in a second processor memory defined by the second address space.

Software components typically include instructions executed by processor 104 in a computing context referred to as a “process”. A process may include one or more “threads”. A “thread” includes a sequence of instructions executed by processor 104 in a computing sub-context of a process. The terms “thread” and “process” may be used interchangeably herein when a process includes only one thread.

Execution environment 102 may receive user-provided information via one or more input devices illustrated by an input device 128. Input device 128 provides input information to other components in execution environment 102 via input device adapter 110. Execution environment 102 may include an input device adapter for a keyboard, a touch screen, a microphone, a joystick, a television receiver, a video camera, a still camera, a document scanner, a fax, a phone, a modem, a network interface adapter, and/or a pointing device, to name a few exemplary input devices.

Input device 128 included in execution environment 102 may be included in device 100 as FIG. 1 illustrates or may be external (not shown) to device 100. Execution environment 102 may include one or more internal and/or external input devices. External input devices may be connected to device 100 via corresponding network interfaces such as a serial port, a parallel port, and/or a universal serial bus (USB) port. Input device adapter 110 may receive input and provide a representation to bus 116 to be received by processor 104, physical processor memory 106, and/or other components included in execution environment 102.

An output device 130 in FIG. 1 exemplifies one or more output devices that may be included in and/or that may be external to and operatively coupled to device 100. For example, output device 130 is illustrated connected to bus 116 via output device adapter 112. Output device 130 may be a display device. Exemplary display devices include liquid crystal displays (LCDs), light emitting diode (LED) displays, and projectors. Output device 130 presents output of execution environment 102 to one or more users. In some embodiments, an input device may also include an output device. Examples include a phone, a joystick, and/or a touch screen. In addition to various types of display devices, exemplary output devices include printers, speakers, tactile output devices such as motion-producing devices, and other output devices producing sensory information detectable by a user. Sensory information detected by a user is referred herein to as “sensory input” with respect to the user.

A device included in and/or otherwise providing an execution environment may operate in a networked environment communicating with one or more devices via one or more network interface components. FIG. 1 illustrates network interface adapter (NIA) 114 as a network interface component included in execution environment 102 to operatively couple device 100 to a network. A network interface component includes a network interface hardware (NIH) component and optionally a network interface software (NIS) component.

Exemplary network interface components include network interface controllers, network interface cards, network interface adapters, and line cards. A node may include one or more network interface components to interoperate with a wired network and/or a wireless network. Exemplary wireless networks include a BLUETOOTH network, a wireless 802.11 network, and/or a wireless telephony network (e.g., AMPS, TDMA, CDMA, GSM, GPRS UMTS, and/or PCS network). Exemplary network interface components for wired networks include Ethernet adapters, Token-ring adapters, FDDI adapters, asynchronous transfer mode (ATM) adapters, and modems of various types. Exemplary wired and/or wireless networks include various types of LANs, WANs, and/or personal area networks (PANs). Exemplary networks also include intranets and internets such as the Internet.

The terms “network node” and “node” in this document both refer to a device having a network interface component to operatively couple the device to a network. Further, the terms “device” and “node” used herein refer to one or more devices and nodes, respectively, providing and/or otherwise included in an execution environment unless clearly indicated otherwise.

The user-detectable outputs of a user interface are generically referred to herein as “user interface elements” or abbreviated as “UI elements”. More specifically, visual outputs of a user interface are referred to herein as “visual interface elements”. A visual interface element may be a visual output of a graphical user interface (GUI). Exemplary visual interface elements include icons, image data, graphical drawings, font characters, windows, textboxes, sliders, list boxes, drop-down lists, spinners, various types of menus, toolbars, ribbons, combo boxes, tree views, grid views, navigation tabs, scrollbars, labels, tooltips, text in various fonts, balloons, dialog boxes, and various types of button controls including check boxes, and radio buttons. An application interface may include one or more of the elements listed. Those skilled in the art will understand that this list is not exhaustive. The terms “visual representation”, “visual output”, and “visual interface element” are used interchangeably in this document. Other types of UI elements include audio outputs referred to as “audio interface elements”, tactile outputs referred to as “tactile interface elements”, and the like.

A “user interface (UI) element handler” component, as the term is used herein, refers to a component that operates to send information representing a program entity to present a user-detectable representation of the program entity by an output device, such as a display. A “program entity” is an object included in and/or otherwise processed by an application or executable. The user-detectable representation is presented based on the sent information. Information that represents a program entity to present a user detectable representation of the program entity by an output device is referred to herein as “presentation information”. Presentation information may include and/or may otherwise identify data in one or more formats. Exemplary formats include image formats such as raw pixel data, JPEG, video formats such as MP4, markup language data such as hypertext markup language (HTML) and other XML-based markup, a bit map, and/or instructions such as those defined by various script languages, byte code, and/or machine code. For example, a web page received by a browser or more generally a user agent from a remote application provider may include HTML, ECMAScript, and/or byte code to present one or more UI elements included in a user interface of the remote application. Components that send information representing one or more program entities to present particular types of output by particular types of output devices include visual interface element handler components, audio interface element handler components, tactile interface element handler components, and the like.

A representation of a program entity may be stored and/or otherwise maintained in a presentation space. As used in this document, the term “presentation space” refers to a storage region allocated and/or otherwise provided to store and/or otherwise represent presentation information, which may include audio, visual, tactile, and/or other sensory data for presentation by and/or on an output device. For example, a memory buffer to store an image and/or text string may be a presentation space as sensory information for a user. A presentation space may be physically and/or logically contiguous or non-contiguous. A presentation space may have a virtual as well as a physical representation. A presentation space may include a storage location in a processor memory, secondary storage, a memory of an output adapter device, and/or a storage medium of an output device. A screen of a display, for example, is a presentation space.

An “interaction”, as the term is used herein, refers to any activity including a user and an object where the object is a source of sensory data detected by the user and/or the user is a source of input for the object. An interaction, as indicated, may include the object as a target of input from the user. The input from the user may be provided intentionally or unintentionally by the user. For example, a rock being held in the hand of a user is a target of input, both tactile and energy input, from the user. A portable electronic device is a type of object. In another example, a user looking at a portable electronic device is receiving sensory data from the portable electronic device whether the device is presenting an output via an output device or not. The user manipulating an input component of the portable electronic device exemplifies the device, as an input target, receiving input from the user. Note that the user in providing input is receiving sensory information from the portable electronic. An interaction may include an input from the user that is detected and/or otherwise sensed by the device. An interaction may include sensory information that is received by a user included in the interaction that is presented by an output device included in the interaction.

As used herein “interaction information” refers to any information that identifies an interaction and/or otherwise provides data about an interaction between a user and an object, such as a portable electronic device. Exemplary interaction information may identify a user input for the object, a user-detectable output presented by an output device of the object, a user-detectable attribute of the object, an operation performed by the object in response to a user, an operation performed by the object to present and/or otherwise produce a user-detectable output, and/or a measure of interaction.

Interaction information for one object may include and/or otherwise identify interaction information for another object. For example, a motion detector may detect a user's head turn in the direction of a display of a portable electronic device. Interaction information indicating that the user's head is facing the display may be received and/or used as interaction information for the portable electronic device indicating the user is receiving visual input from the display. The interaction information may serve to indicate a lack of user interaction with one or more other objects in directions from the user different than the detected direction, such as a person approaching the user from behind the user. Thus the interaction information may serve as interaction information for one or more different objects.

As used herein, the terms “program” and “executable” refer to any data representation that may be translated into a set of machine code instructions and may optionally include associated program data. The terms are used interchangeably herein. Program representations other than machine code include object code, byte code, and source code. Object code includes a set of instructions and/or data elements that either are prepared to link prior to loading or are loaded into an execution environment. When in an execution environment, object code may include references resolved by a linker and/or may include one or more unresolved references. The context in which this term is used will make clear the state of the object code when it is relevant. This definition can include machine code and virtual machine code, such as Java™ byte code. A program and/or executable may include one or more components, referred to herein as a “program component”, a “software component”, and/or an “executable component”. As used herein, the terms “application”, and “service” may be realized in one or more program components and/or in one or more hardware components.

As used herein, the term “network protocol” refers to a set of rules, conventions and/or schemas that govern how nodes exchange information over a network. The set may define, for example, a convention and/or a data structure. The term “network path” as used herein refers to a sequence of nodes in a network that are communicatively coupled to transmit data in one or more data units of a network protocol between a pair of nodes in the network.

A “data unit”, as the term is used herein, is an entity specified defined and/or otherwise specified by a network protocol to transmit data between a pair of nodes in a network path to send the data from a source node to a destination node that includes an identified protocol endpoint of the network protocol. A network protocol explicitly and/or implicitly specifies and/or otherwise identifies a schema that defines one or more of a rule for a format for a valid data unit and a vocabulary for content of a valid data unit. One example of a data unit is an Internet Protocol (IP) packet. The Internet Protocol defines rules for formatting an IP packet that defines a header to identify a destination address that identifies a destination node and a payload portion to include a representation of data to be delivered to the identified destination node. Various address types are specified defining a vocabulary for one or more address portions of an IP data unit. The terms “data unit”, “frame”, “data packet”, and “packet” are used interchangeably herein. One or more data units of a first network protocol may transmit a “message” of second network protocol. For example, one or more data units of the IP protocol may include a TCP message. In another example, one or more TCP data units may transmit an HTTP message.

How data is packaged in one more data units for a network protocol may vary as the data traverses a network path from a source node to a destination node. Data may be transmitted in a single data unit between two consecutive nodes in a network path. Additionally, data may be exchanged between a pair of consecutive nodes in several data units each including a portion of the data. Data received in a single data unit by a node in a network path may be split into portions included in several respective data units to transmit to a next node in the network path. Portions of data received in several data units may be combined into a single data unit to transmit by a node in a network path. For purposes of describing the subject matter, a data unit in which data is received by a node is referred to as a different data unit than a data unit in which the data is forwarded by the node.

A “protocol address”, as the term is used herein, for a network protocol is an identifier of a protocol endpoint that may be represented in a data unit of the network protocol. For example, 192.168.1.1 is an IP protocol address represented in a human readable format that may be represented in an address portion of an IP header to identify a source and/or a destination IP protocol endpoint. A protocol address differs from a symbolic identifier, defined below, in that a symbolic identifier, with respect to a network protocol, maps to a protocol address. Thus, “www.mynode.com” may be a symbolic identifier for a node in a network when mapped to the protocol address 192.168.1.1. An identifier may be both a symbolic identifier and a protocol address depending on its role with respect to its use for a particular network protocol.

Since a protocol endpoint is included in a node and is accessible via a network via a network interface, a protocol address identifies a node and identifies a network interface of the node. A network interface may include one or more NICs operatively coupled to a network.

Those skilled in the art will understand upon reading the descriptions herein that the subject matter disclosed herein is not restricted to the network protocols described and/or their corresponding OSI layers.

As used herein, the term “communication” refers to data exchanged via a network protocol along with an identifier that identifies a user as a sender of the data and/or as a receiver of the data. The identifier is included in a data unit of the network protocol and/or in a message transported by the network protocol. The network protocol is referred to herein as a “communications protocol”. The sender is referred to herein as a “contactor”. The receiver is referred to herein as a “contactee”. The terms “contactor” and “contactee” identify roles of “communicants” in a communication. The contactor and the contactee are each a “communicant” in the communication. An identifier that identifies a communicant in a communication is referred herein as a “communicant identifier”. The terms “communicant identifier” and “communicant address” are used interchangeably herein. A communicant identifier that identifies a communicant in a communication exchanged via a communications protocol is said to be in an identifier space or an address space of the communications protocol. The data in a communication may include text data, audio data, image data, and/or a program component.

A communications protocol defines one or more rules, conventions, and/or vocabularies for constructing, transmitting, receiving and/or otherwise processing a data unit of and/or a message transported by the communications protocol. Exemplary communications protocols include a simple mail transfer protocol (SMTP), a post office protocol (POP), an instant message (IM) protocol, a short message service (SMS) protocol, a multimedia message service (MMS) protocol, a Voice over IP (VOIP) protocol. Any network protocol that specifies a data unit and/or transports a message addressed with a communicant identifier is or may operate as a communications protocol. In a communication, data may be exchanged via one or more communications protocols. Exemplary communicant identifiers include email addresses, phone numbers, multi-media communicant identifiers such as SKYPE® IDs, instant messaging identifiers, MMS identifiers, and SMS identifiers.

A user in the role of a communicant interacts with a communications agent to receive data addressed to the user in a communication. Alternatively or additionally, a user in the role of a communicant interacts with a communications agent to send data addressed to another communicant in a communication. More generally, the term “communications agent” refers to a component or application that operates in an execution environment to receive, on behalf of a contactee, a communicant message address to the contactee by a communicant identifier in the communication. The communications agent interacts with the contactee communicant in presenting and/or otherwise delivering the communicant message. Alternative or additionally, a communications agent operates in an execution environment to send, on behalf of a contactor, a communicant message in a communication addressed to a contactee by a communicant identifier in the communication. A communications agent that operates on behalf of a communicant in the role of a contactor and/or a contactee as described above is said, herein, to “represent” the communicant.

A “communicant message” data spoken, written, and/or acted by a contactor for a contactee. The data is received by a communications agent representing the contactor and is further received and/or to be received in a communication by a communications agent to present via an output device to the contactee identified in the communication by a communicant identifier. Examples of communicant messages include text written by a contactee in an email and/or an instant message and a spoken message by a contactee included in an audio communication by a VoIP client. To be clear attachments, data unit headers, message headers, communication session control data, and/or connection data for setup and management of a communication are not communicant messages as defined herein.

The term “communicant alias” as used herein refers to an identifier of a communicant in a communication where the communicant alias is not a communicant identifier in an address space of a communication protocol via which the communication is exchanged.

The term “attachment” as used herein refers to data, that is not a communicant message, exchanged in a communication from a sending communications agent and/or communications service to a recipient communications agent and/or communications service. An attachment may be, for example, a copy of a file stored and/or otherwise represented in a file system and/or in another data store in an execution environment that includes a communications agent included in exchanging the attachment in a communication. A resource sent as an attachment is data that is typically not presented “inline” in a communicant message. Email attachments are perhaps the most widely known attachments included in communications. An email attachment is a file or other data resource sent in a portion of an email separate from a communicant message portion. As defined, other communicant messages may be sent in other types of communications along with one or more attachments.

A “communications request”, as the term is user herein, refers to request sent by a communications agent via a communications protocol. A “communications response”, as the term is user herein, refers to any response corresponding to a communications request. A communications response may be transmitted via the same communications protocol as its corresponding communications request, a different communications protocol, a web protocol, and/or via any other suitable network protocol. A “communications service”, as the term is used herein, refers to a recipient of a communications request that is included in performing the request. Performing the request may include sending a service request based on the communications request to a service application included in performing the request. A communications service and/or a service application included in performing a communications request may generate a communications response to the request.

“Service application”, as the term is used herein, refers to any application that provides access to a resource. “Resource”, as the term is user herein, refers to a data entity, a hardware component, a program component, and/or service. A service request is a request to a service application to get, create, modify, delete, move, and/or invoke a resource. A response to a service request is referred to as a service response. Data in a service response is a resource. A communications request is a type of service request.

A “web protocol”, as the term is used herein, refers to any version of a hypertext transfer protocol (HTTP) and/or any version of a HTTP secure (HTTPS) protocol. A “user agent”, as the term is used herein, refers to a client which initiates a request via a web protocol. Examples include web browsers, HTML editors, spiders (web-traversing robots), or other end user tools. A “web request”, as the term is used herein, refers to a request initiated by a user agent. A “web service”, as the term is used herein, refers to a recipient of a web request. A web service generates a response to the request. A “web response”, as the term is used herein, refers to any response that corresponds to a web request. A web response may be transmitted via the same web protocol as its corresponding web request, a different web protocol, via a communications protocol, and/or via any other suitable network protocol. A web request is a type of service request.

A “service provider”, as the term is used herein, refers to any entity that owns, maintains, and/or otherwise provides a web service, communications service, and/or other network accessible service application. The term “service provider system” is used interchangeably with services and facilities that host a web service and/or other service application of a service provider. For example, a service provider system may include a server farm, a content delivery network, a database, a firewall, etc.

“Access information” of a user is information that enables an execution environment hosting a communications agent representing the user to access a service application to process a communication request received from another communications agent representing another user. Access information may include authentication information and/or authorization information. Access information may include and/or may otherwise identify a protocol address of a network protocol endpoint, a symbolic identifier, a time and/or schedule for processing the request, a location, a route, a password, a pin, an account identifier, a payer, a payee, a digital signature, a digital certificate, an encryption key, a secure protocol, a type of encoding, a schema, and a data transform—too name a few examples.

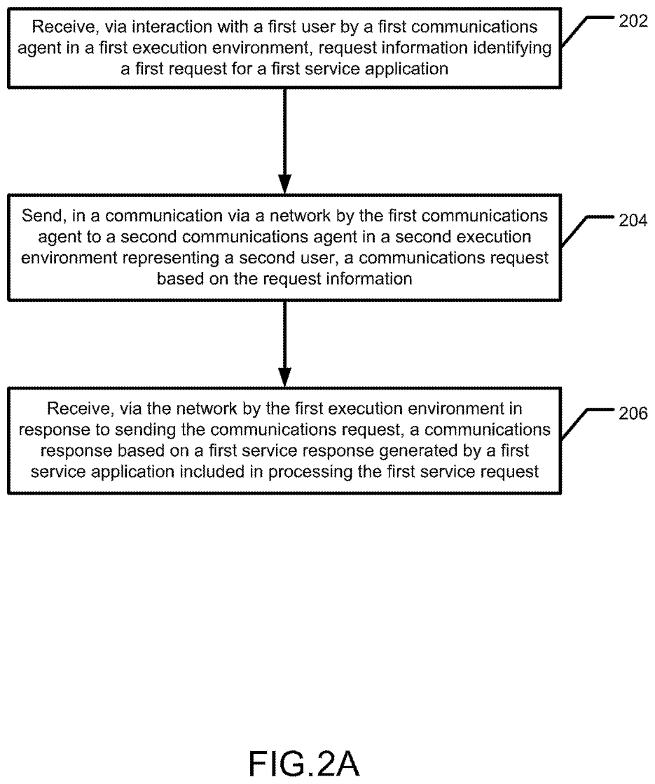

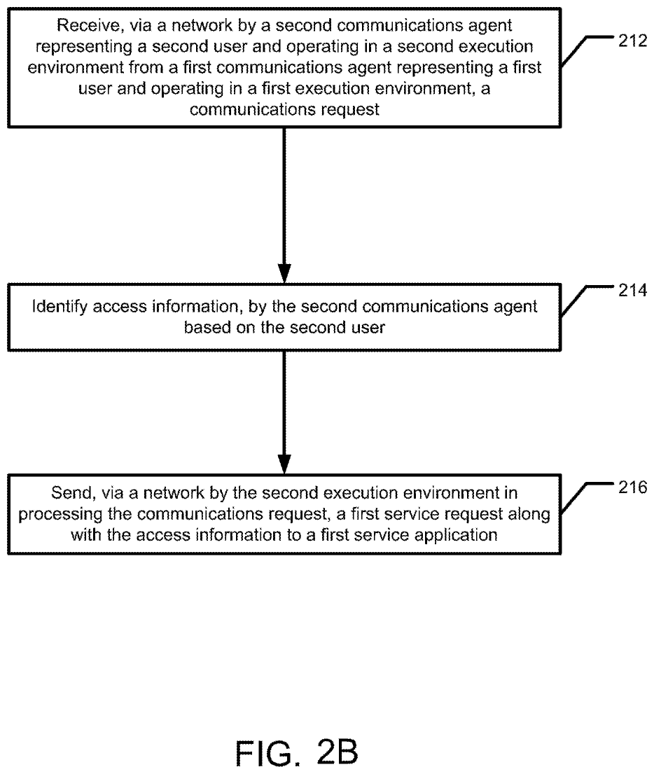

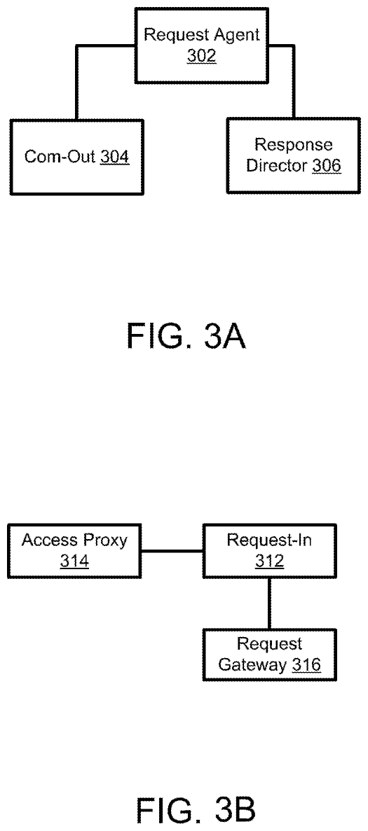

FIG. 3A illustrates an arrangement of components in a system that operates in an execution environment, such as execution environment 102 in FIG. 1. The arrangement of components in the system operates to perform the method illustrated in FIG. 2A. The system illustrated includes a request agent component 302, a com-out component 304, and a response director component 306. A suitable execution environment includes a processor, such as processor 104, to process an instruction in at least one of the request agent component, the com-out component, and the response director component. FIG. 3B illustrates an arrangement of components in a system that operates to perform the method illustrated in FIG. 2B. The system illustrated includes a request-in component 312, an access proxy component 314, and a request gateway component 316. A suitable execution environment includes a processor, such as processor 104, to process an instruction in at least one of the request-in component, the access proxy component, and the request gateway component.

Some components, illustrated in the drawings are identified by numbers with an alphanumeric suffix. A component may be referred to generically in the singular or the plural by dropping a suffix of a portion thereof of the component's identifier. For example, execution environments; such as requesting execution environment 401a, access execution environment 401b, service execution environment 401c, and their adaptations and analogs; are referred to herein generically as an execution environment 401 or execution environments 401 when describing more than one. Other components identified with an alphanumeric suffix may be referred to generically or as a group in a similar manner.

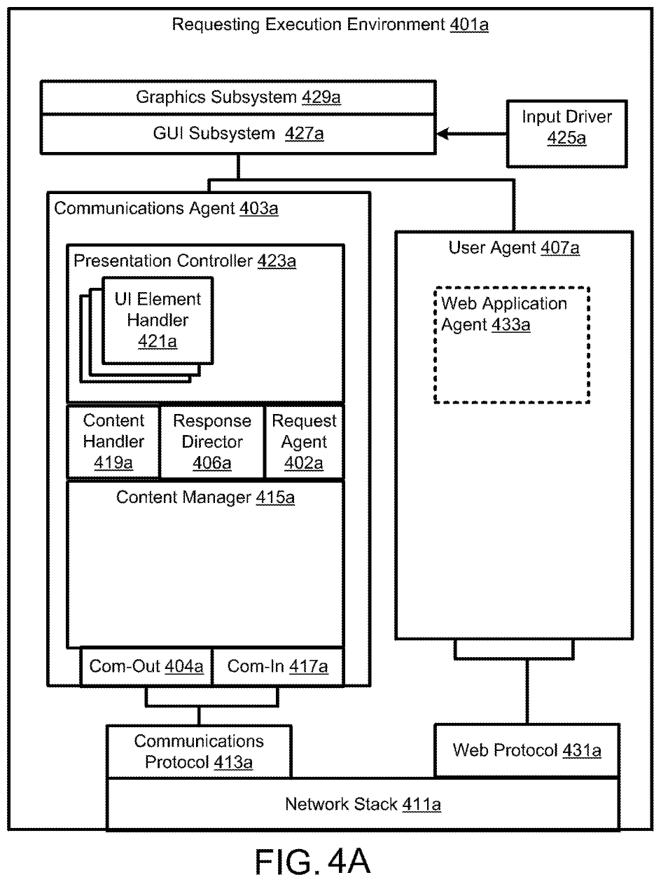

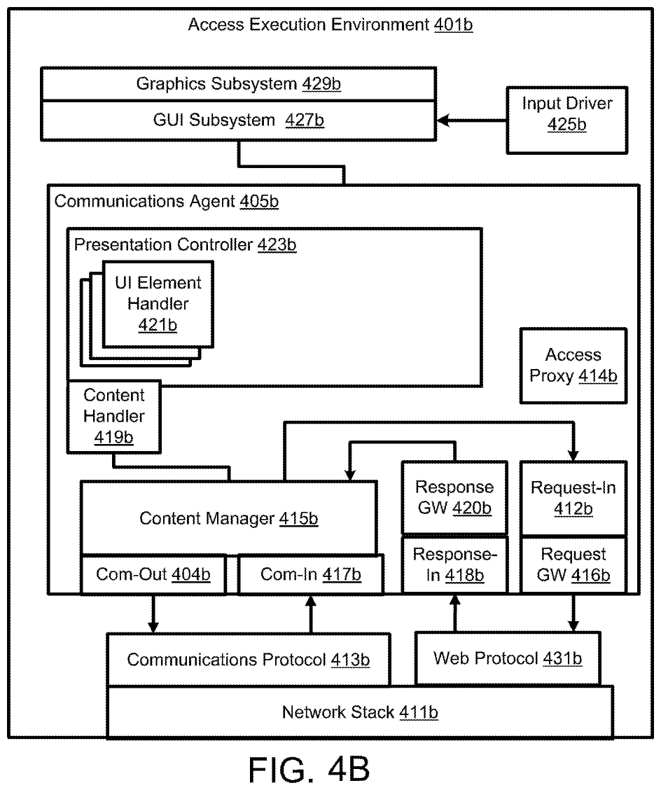

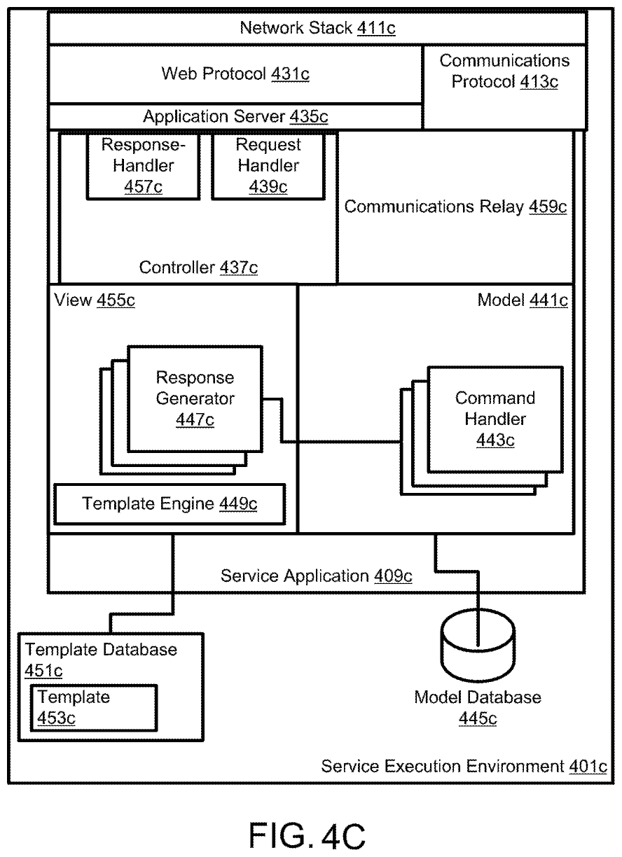

Some or all of the exemplary components illustrated in FIG. 3A and in FIG. 3B, their adaptations, and/or their analogs may operate in a number of execution environments to perform the method illustrated in FIG. 2A and/or the method illustrated in FIG. 2B. FIG. 4A is a block diagram illustrating the components of FIG. 3A and/or analogs of the components of FIG. 3A that operate in a first execution environment referred to herein for illustrative purposes as a requesting execution environment 401a to perform the method illustrated in FIG. 2A. FIG. 4B is a block diagram illustrating the components of FIG. 3B and/or analogs of the components of FIG. 3B that operate in a second execution environment referred to herein for illustrative purposes as an access execution environment 401b to perform the method illustrated in FIG. 2B. In an aspect (not shown), the components of FIG. 3B and/or analogs of the components of FIG. 3B may be operate in service execution environment 401c along with the components illustrated in execution environment 401c in FIG. 4C.

Each execution environment 401 in FIGS. 4A-C is included in and/or otherwise is provided by one or more nodes. FIG. 1 illustrates key components of an exemplary device that may at least partially provide and/or otherwise may be included in an execution environment. The components illustrated in FIGS. 4A-C may be included in or may otherwise be combined with the components of FIG. 1 to create a variety of arrangements of components according to the subject matter described herein.

As stated, the various adaptations of the arrangement in FIG. 3A as well as the various adaptations of the arrangement in FIG. 3B illustrated and described herein are not exhaustive. For example, those skilled in the art will see, based on the description herein, that arrangements of components to perform the method illustrated in FIG. 2A and the method illustrated in FIG. 2B may each be distributed across more than one node and/or execution environment.

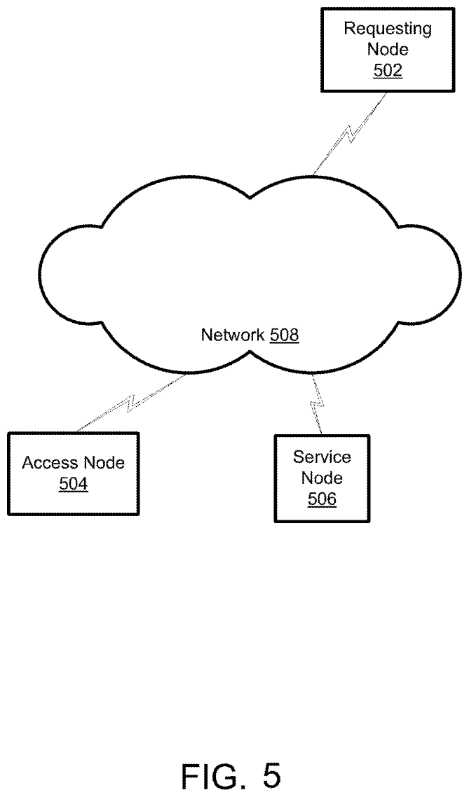

FIG. 5 illustrates a first node referred to herein for illustrative purposes as a requesting node 502, a second node referred to herein for illustrative purposes as an access node 504, and a third node referred to herein for illustrative purposes as a service node 506 as exemplary devices that each may be included in and/or otherwise may provide an instance, adaptation, and/or analog of an execution environment 401 in any of FIGS. 4A-C. Requesting execution environment 401a may include and/or may otherwise be provided at least in part by requesting node 502. Access execution environment 401b may include and/or may otherwise be provided, at least in part, by access node 504. Service execution environment 401c may include and/or may otherwise be provided, at least in part, by service node 506.

Requesting execution environment 401a of requesting node 502 and access execution environment 401b of access node 504 are operatively coupled via respective network interface components and network 508. Access execution environment 401b of access node 504 and service execution environment 401c of service node 506 are also operatively coupled via respective network interface components. Requesting execution environment 401a of requesting node 502 and service execution environment 401c of service node 506 may be operatively coupled via respective network interface components and network 508. In an aspect, requesting execution environment 401a may be operatively coupled to service execution environment 401c via an access execution environment 401b. For example, service node 506 may be coupled to network 508 through access node 504.

FIGS. 4A-C illustrate various applications in respective execution environments 401. FIG. 4A illustrates an adaptation of the arrangement of components in FIG. 3A in a communications agent application illustrated as requesting communications agent 403a. Communications agent 403a may operate in requesting execution environment 401a of requesting node 502 on behalf of a requesting communicant to communicate with another communications agent, such as access communications agent 405b, illustrated in FIG. 4B operating in access execution environment 401b of access node 504, in FIG. 5. FIG. 4A also illustrates a user agent 407a application, such as a web browser. User agent 407a may operate in requesting execution environment 401a of requesting node 502 to communicate with one or more service applications, such as service application 409c, illustrated in FIG. 4C, which may operate as a web service, in service execution environment 401c of service node 506.

Access communications agent 405b, like requesting communications agent 403a, represents a communicant. For illustrative purposes, a communicant of an access communications agent is referred to herein as an access communicant. Exemplary communications agents include email clients, phone clients including Voice over Internet Protocol (VoIP) clients, instant messaging clients, short message service (SMS) clients, multimedia message service (MMS clients), multi-media communications clients including video phone clients, and other communications agents.

Applications in FIG. 4A-C, operating in respective execution environments 401 may interoperate via respective network stacks 411. Applications may exchange data via network 508, in FIG. 5, via one or more communications protocols. FIG. 4A-C each illustrate respective communications protocol components 413 exemplifying subsystems to exchange data via network 508 according to one or more communications protocols, such as simple mail transfer protocol (SMTP), a post office protocol (POP), an instant messaging (IM) protocol, and/or a real-time voice and/or video protocol. A communication between applications may include more than one type of data and may use one or more communications protocols in exchanging data via network 508.

Instances, adaptations, and/or analogs of applications in FIG. 4A-C may communicate via a request/reply protocol, data streaming protocol, a session and/or connection-oriented protocol, a connectionless protocol, a real-time communications protocol, an asynchronous protocol, a store and forward communications protocol, a reliable delivery communications protocol, a best-effort delivery communications protocol, and/or a secure protocol, to name a few communications options.

FIGS. 4A-B illustrate communications agents, requesting communications agent 403a and access communications agent 405b respectively. Each is illustrated including a content manager component 415. A content manager component 415 may interoperate with a communications protocol layer component 413 and/or network stack 411 to send and/or receive data in one or more communications via network 508, in FIG. 5, with another communications agent, a communications relay, a communications switch, and or other compatible component in another execution environment and/or node. A content manager component 415 may be operatively coupled, via a com-in component 417, to a communications protocol component 413 to receive the data from communications agents in other nodes.

Data received in a communication may include one or more resources of one or more content types. Exemplary content types include plain text, markup such as hypertext markup language (HTML), audio data, image data, and/or executable data. Executable data may include script instruction(s), byte code, and/or machine code. In FIG. 4A and in FIG. 4B, requesting communications agent 403a and access communications agent 405b may respectively include one or more content handler components 419 to process data received according to its content type. A data type may be identified by a MIME type identifier and/or a file type extension, for example. Exemplary content handler components 419 include a text/html content handler component to process HTML representations; an application/xmpp-xml content handler component to process extensible messaging and presence protocol (XMPP) streams including presence tuples, instant messages, and audio content handlers including and/or configured to retrieve suitable codices; one or more video content handler components to process video representations of various types; and still image data content handler components to process various image data representations.

Content handler component(s) 419 process received data representations and may provide transformed data from the representations to one or more user interface element handler components 421. One or more user interface element handler components 421 are illustrated in respective presentation controllers 423 in FIGS. 4A-B. A presentation controller 423 may manage visual, audio, and other types of output for its including application as well as receive and route detected user input and event data to components and extensions of its including application. A user interface element handler component 421 may operate at least partially in a content handler component 419 such as a text/html content handler component and/or a script content handler component. Additionally or alternatively, a user interface element handler component in an execution environment 401 may be received in a communication. For example, a communication, such as an email, may include an HTML content type portion and a script content type portion.

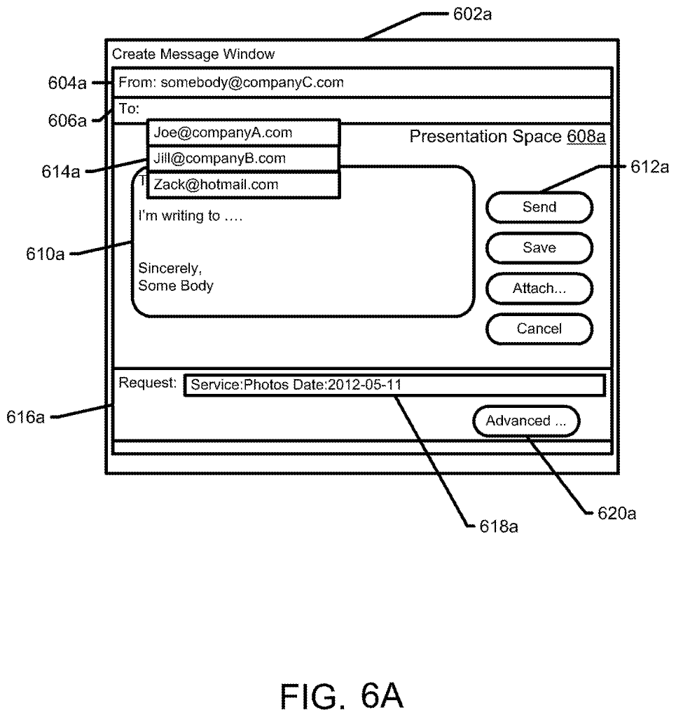

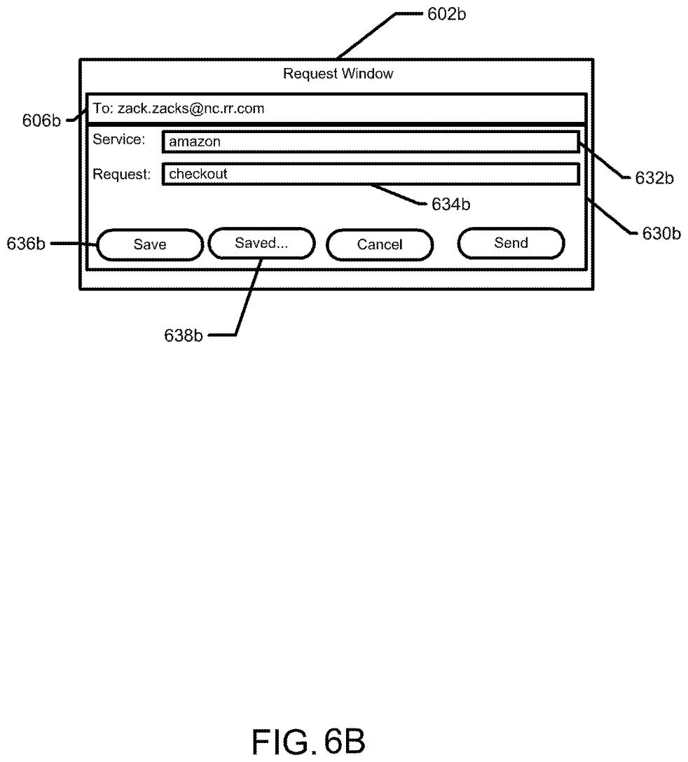

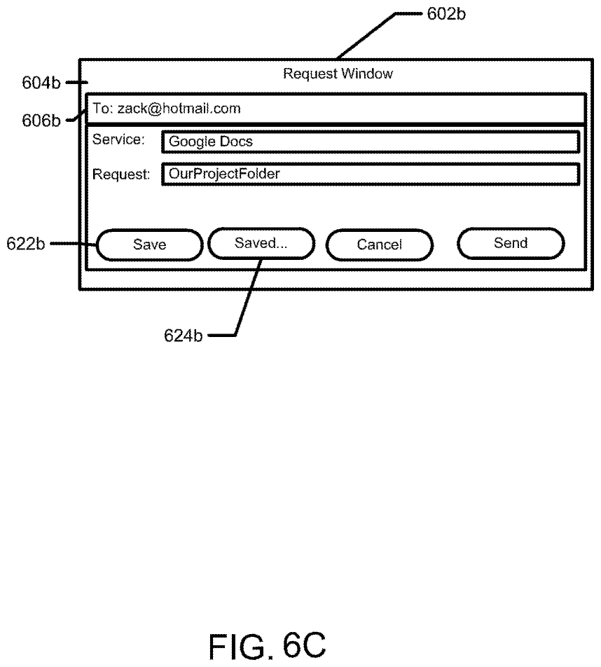

FIGS. 6A-C illustrate various windows 602 presentable in a presentation space of a display device, such as output device 130 in FIG. 1. A create message window UI element 602a, in FIG. 6A, includes a contactor user interface (UI) element 604a to present an identifier of a communicant in the role of a contactor in a communication. UI element 602a also includes a contactee UI element 606a to present one or more contactee identifier(s) identifying one or more communicants in the role of contactee(s) included in the communication. A presentation space 608a is provided in a view window 602a to present a communicant message UI element 610a to present a communicant message addressed to one or more contactees identified in contactee UI element 606a. The presentation space 608a may also be provided to present one or more UI controls to exchange data in and/or otherwise manage the communication. A send UI element 612a illustrates an exemplary UI element that may correspond to user input to send data in a communication to one or more identified contactees.

Data to send in a communication to a communications agent may be received by one or more content handler component(s). For example, in FIG. 4A, a content handler component 419a may operate in requesting communications agent 403a to transform data from one or more UI element handler components 421a into one or more data representations suitable to transmit in a communication and/or suitable to process by another communications agent, such as access communications agent 405b in access execution environment 401b. The one or more data representations may be provided to content manager component 415a to send in the communication to one or more communications agents. Content manager component 415a may package and/or otherwise prepare for packaging the one or more data representations in a data unit or message formatted according to a communications protocol of the communications agent 403a. Communications protocol component 413a may send the data according to the specification(s) of the communications protocol. Content manager component 415a may alternatively or additionally encode and/or otherwise transform one or more of the data representations to send in a data stream such as voice stream and/or a video stream to communicate in the communication to a communications agent via a network.

Content manager component 415a operating in requesting execution environment 401a may provide the packaged, encoded, and/or transformed data to communications protocol component 413a via a com-out component 404a. Com-out component 404a, as described above, operatively couples content manager component 415a to communications protocol component 413a according to an interface provided by communications protocol component 413a to send data in a communication. Communications protocol component 413a may further package and/or otherwise transform the data to send via network stack 411a to deliver via network 508 to another communications agent based on a contactee communicant identifier.

A communicant in a communication may be identified by a communicant identifier in an address space of a communications protocol. In one aspect, information identifying a communicant identifier may be received from a communicant of a communications agent in an execution environment. In FIG. 4A, presentation controller 423a and/or a UI element handler 421a, may present and/or manage interaction with contactor UI element 604 in FIG. 6A presented by requesting execution environment 401a. Presentation controller 423a and/or a UI element handler 421a may receive a contactor alias and/or a communicant identifier in response to a user input corresponding to contactor UI element 604. The user of requesting execution environment 401a may enter a contactor alias, such a user's name, via a keyboard and/or may select a predefined communicant alias and/or communicant identifier presented in a selection UI control element via a UI element handler component 421a. The user input may be detected by input driver 425a. Corresponding input information may be routed to presentation controller 423a by GUI subsystem 427a. GUI subsystem 427a may send presentation information to a display device via a graphics subsystem 429a. Communications agent 403a may identify a communicant identifier associated with the contactor alias, such as “somebody@companyC.com”. Other communicant identifier, such as for one or more contactees, may be received similarly and/or in any suitable manner.

Data may be sent in a communication according to a form or type of the communication and/or other attribute of the communication such as a security attribute, the amount of data to be sent, a priority setting, a task setting, and the like. Some forms of communication do not require a session and/or connection between communications agents in a communication in order to exchange data in the communication, while others do. An email and/or instant message may use a store and forward model of delivery.

Data may be sent in a communication in response to a communicant input. A contactor may provide an input corresponding to send UI element 612a in FIG. 6A. The input may be received by presentation controller 423a, in FIG. 4A, and/or by one or more UI element handlers 421a corresponding to send UI element 612a. In response to detecting the input, presentation controller 423a may provide data to be sent in the communication to one or more content handler components 419a according to the content type(s) of the data to be sent.

The one or more content handler components 419a may encode, format, and/or otherwise transform the data to send in a communication, such as in an email message. The one or more content handler components 419a may provide data to be sent to content manager 415a, instructing content manager component 415a to send the data in the communication to deliver to another communications agent. Content manager component 415a interoperating with com-out component 404a may further format and/or transform the data to send in the communication according to a communications protocol, for example according to an email communications protocol, by communications protocol component 413a. Communications protocol component 413a may send the communication to deliver to another communications agent, such as access communications agent 405b via network 508.

For session-oriented and/or connection-oriented communication a session and/or connection may be established if a session/connection has not already been established. Data may be sent to deliver to a communications agent identified based on a contactee communicant identifier during session and/or connection setup. For example, for a voice communication, the voice communication may be established via a session initiation protocol. Communications protocol component 413a may operate according to the session initiation protocol specifications. Communications protocol component 413a operating in requesting execution environment 401a may locate a communications agent and/or an access communications agent by communicating with one or more nodes in network 508 according to the session initiation protocol. Communications protocol component 413a may locate, for example, access communications agent 405b in access execution environment 401b, based on a communicant identifier for a contactee in the communication.

Once a communication session is established, such as a voice session, data may be sent according to the session communications protocol, such as RTP, or some other communications protocol. For example, data may be sent according to a session initiation protocol in the communication to manage the voice communication session and/or to exchange text, image, and/or other data outside of the voice session.

FIG. 4A includes a second application illustrated by user agent 407a. As defined above, user agent 407a may be a web browser. User agent 407a in FIG. 4 and service application 409c in FIG. 4C may interoperate via respective network stacks 411 in requesting execution environment 401a and service execution environment 401c. User agent 407a and service application 409c may communicate via one or more web protocols when the service application operates as a web service. FIG. 4A and FIG. 4C respectively illustrate web protocol components 431. Web protocol components 431 in requesting execution environment 401a and in service execution environment 401c may exchange data via one or more versions of the Hypertext Transfer Protocol (HTTP).

User agent 407a, in FIG. 4A, may receive some or all of web application agent 433a in one more web responses sent from service application 409c, in FIG. 4C via network stacks, network interface components, and web protocol components in the respective execution environments. In FIG. 4A, user agent 403a may interoperate with web protocol component 431a and/or network stack 411c to receive the web response(s) including some or all of web application agent 433a.

Web application agent 433a may include a web page or other data representation to provide a user interface for service application 409c. The web page may include and/or reference data represented in one or more formats including hypertext markup language (HTML) and/or other markup languages, ECMAScript or other scripting languages, byte code, image data, audio data, and/or machine code to name just a few valid data representations depending on the capabilities of a receiving user agent node.

A controller component 437c, in FIG. 4C, may receive a web request from a user agent via an application server 435c. A request handler component 439c in controller component 437c may invoke model subsystem 441c to perform request specific processing. Model subsystem 441c may include any number of command processors, illustrated as command handler components 443c, that may dynamically generate data and/or retrieve data from model database 445c based on the command included in performing the request. Controller component 437c may further invoke one or more response generator components 447c to generate a response to the received request. The one or more response generator components 447c may invoke template engine component 449c to identify one or more templates and/or other static data to combine with data received from command handler component(s) 443c generated in processing the request. FIG. 4C illustrates template database 451c including one or more templates illustrated by template 453c. The one or more response generator component(s) 447c in view subsystem 455c may interoperate with response handler component 457c in controller component 437c to return a response generated from processing a request. The response may be returned in one or more data formats suitable for a user agent, such as a browser. Response handler component 457c may receive command response data from one or more response generator components 447c as one or more HTTP entities, and/or one or more HTTP representations. Alternatively or additionally, response handler component 457c may transform data from one or more response generator component(s) 447c into one or more HTTP entities and/or HTTP representations. Response handler component 457c may send the one or more HTTP entities in an HTTP response, in response to a HTTP request received from user agent 407a. Some or all of a web application agent 433a may be sent to user agent 407a via network application server 435c in the manner described.

One or more HTTP responses including one or more representations of some or all of web application agent 433a may be received by user agent 407a via web protocol component 431a and network stack 411a. In FIG. 4A, user agent 407a may include one or more content handler components to process received HTTP representations according to their data types, typically identified by MIME-type identifiers. Exemplary content handler components that operate in and/or with user agent 407a include a text/html content handler component for processing HTML representations; an application/xmpp-xml content handler component for processing XMPP streams including presence tuples, instant messages, and publish-subscribe data as defined by various XMPP specifications; one or more video content handler components for processing video representations of various types; and still image data content handler components for processing various image data representations. Content handler component(s) in user agent 407a process received HTTP representations and may provide data from the HTTP representations to one or more user interface element handler components included and/or otherwise interoperating with user agent 407a.

User agent 407a may manage visual, audio, and other types of output. User agent 407a may send presentation information to present one or more UI element via an output device, such as a display device. The display device may include a presentation space to represent a UI element, such as a browser window or tab The UI element may be presented by and/or on behalf of user agent 407a, web application agent 433a, and/or service application 409c which may include and/or may be included in a web service.

FIGS. 4A-C illustrates respective web protocol components 431 that may interoperate with access communications agent 405b. An access communications agent 405 may operate as a user agent in communicating with a service application operating as a web service. FIG. 4C illustrates service application 409c operatively coupled to web protocol component 431c to exchange data with one or more user agents, such as user agent 407a in FIG. 4A and/or access communications agent 405b in FIG. 4B. In an aspect, service application 409c may be operatively coupled to a communications protocol component 413c as FIG. 4C illustrates. Service application 409c may exchange data in a communication with a communications agent, such as communications agent 403a, in FIG. 4A, and/or an access communications agent 405b, in FIG. 4B.

With reference to FIG. 2A, a block 202 illustrates that the method includes receiving, via interaction with a first user by a first communications agent in a first execution environment, request information for identifying a first service request. Accordingly, a system for accessing a service via a proxy communications agent includes means for receiving, via interaction with a first user by a first communications agent in a first execution environment, request information for identifying a first service request. For example, the arrangement in FIG. 3A, includes request agent component 302 that is operable for and/or otherwise included in receiving, via interaction with a first user by a first communications agent in a first execution environment, request information for identifying a first service request. FIG. 4A illustrates request agent component 402a as an adaptation and/or analog of the request agent component 302 in FIG. 3A. One or more request agent components 402 operate in an execution environment 401. A system for accessing a service via a proxy communications agent includes one or more processors and logic encoded in one or more computer readable media for execution by the one or more processors that when executed is operable for and/or otherwise included in receiving, via interaction with a first user by a first communications agent in a first execution environment, request information for identifying a first service request.

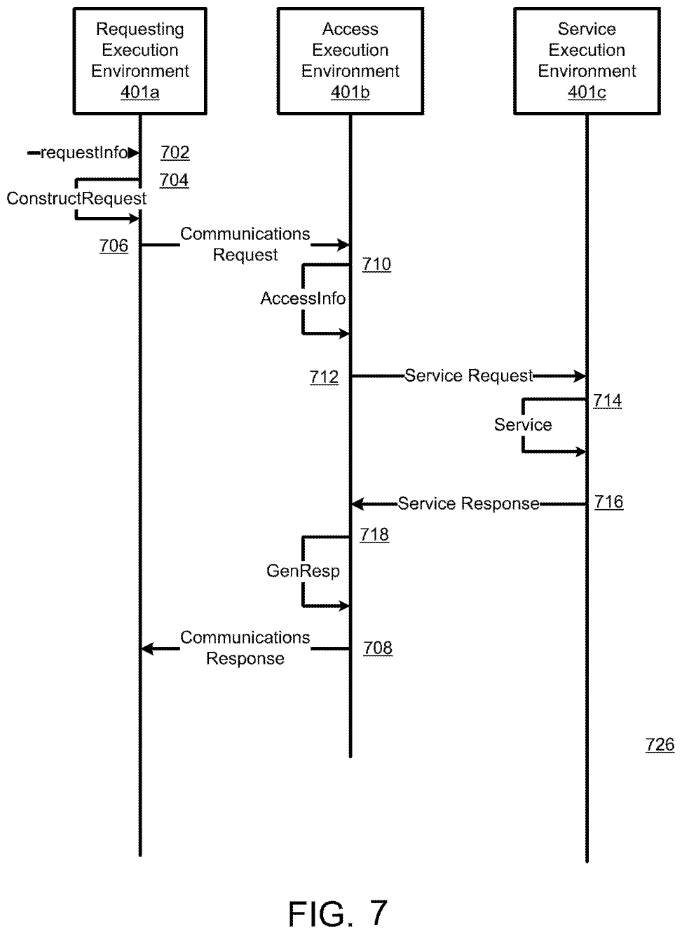

FIG. 7 illustrates a request information (requestInfo) dataflow 702 that may be a dataflow internal to requesting execution environment 401a in FIG. 4A and/or may include receiving data via network 508 by requesting execution environment 401a. Request information dataflow 702, in FIG. 7, may include receiving user input information by and/or otherwise identified to a UI element handler component 421a in communications agent 403a, in response to user input. A request agent component 402a may receive the request information based on the input information. In another aspect, request information dataflow 702 may include data identifying request information received by content manager component 415a, in FIG. 4A, via network 508 from, for example, a user agent operating in a node (not shown) in network 508. A request agent component 402a may receive the identified request information via interoperation with content manager component 415a.

Receiving request information may include presenting a UI element, as illustrated in each of FIGS. 6A-C, to a user to receive input information, via an output device. The request information may be received from the user via an input, detected by an input device. The input may correspond to the request information UI element.

A request information UI element may be presented by a requesting communications agent in a user interface element presented to create a new communicant message; a user interface element presented to reply to a previously received communicant message; a user interface element presented to receive the request information where the requesting communicant is not allowed create, reply to, and/or otherwise edit a communicant message; and/or a main application window of the requesting communications agent.

Those skilled in the art will understand that numerous languages and/or schemas for providing request information for various types of requests. Request information may identify a URI, such as a URL; a search query, and/or otherwise a request to perform an operation by a resource and/or to retrieve, modify, create, and/or update a resource. For example, request information may include and/or otherwise identify search information to create a search query or search request for a search engine. Request information may identify a resource such a file and/or a service to access. Request information may include data to store and/or otherwise process by a service application.

FIG. 6A illustrates an exemplary user interface that may be presented to create a new communicant message via interaction with a user. The user interface in FIG. 6A may be presented by communications agent 403a, in FIG. 4A, operating in requesting execution environment 401a of requesting node 502 in FIG. 5. A UI element handler component 421a may operate to present a user interface element to allow a user to identify request information, for example, to perform a search, request a service, and/or to receive a resource as a response to the request. A request information UI element 616a is illustrated in FIG. 6A as an example. The same or different UI element handler component 421a may present various other UI elements included in request information UI element 616a. Request information UI element 616a and one or more UI elements it includes may be presented by one or more corresponding UI element handler component(s) 421a that may operate based on a schema that defines valid request information to create a communications request by communications agent 403a. The schema defines one or more rules and/or a vocabulary that defines whether request information is valid.

A request information UI element, as described above, may be included in a plurality of request information UI elements presentable by a requesting communications agent. Presenting a request information UI element may include selecting and/or otherwise identifying, based on a service application, the request information UI element from the plurality of request information UI elements. The selected request information UI element may be presented in response to and/or otherwise based on the selection. For example, a service type may be identified, such as document management service based on communication previously received by communications agent 403a in FIG. 4A. A content handler component 419a, for example, may detect service information in the communication. The content handler component 419a may identify one or more services, service types, and/or other attributes of one or more services accessible by a communications agent of a communicant identified in the previously received communication. A presentation controller component 423a may identify a request information UI element from a plurality of request information UI elements based on the service information. For example, requesting execution environment 401a may include and/or otherwise have access to a data store including one or more records that associate service information or a portion thereof with a request information UI element.

A communications agent and/or an execution environment, in which the communications agent operates, may, in an analogous manner alternatively or additionally, select and/or otherwise determine a request information UI element from a plurality of request information UI elements, based on a communicant identifier included in the communication. The communicant identifier identifies a communicant in a communication. The communicant may be contactee and/or a contactor. A request information UI element may be associated directly and/or indirectly with a communicant. As such, the request information UI element may be selected based on the requesting communicant.

In an aspect, presenting the first request information UI element may include selecting, based on a first user of a requesting communications agent, a request information UI element from the plurality of request information UI elements. The selected request information UI element may be presented by a presentation controller component 423a in the requesting communications agent 403a. Selection information may be received via UI element handler component 421a from the user via an input device. The selection information may identify the request information UI element directly and/or indirectly. The selection information may be processed as an indication to present the selected request information UI element.

Request information UI element 616a illustrates a user interface for a keyword based schema for receiving digital photographs. Request textbox UI element 618a illustrates a textbox allowing a user to enter a keyword expression. An advanced button UI element 620a allows communications agent 403a to receive additional request information. A user input detected that corresponds to advanced button UI element 620a may result in communications agent 403a presenting a dialog box including one or more form UI elements to receive input from the user that specify advanced request options. Communications agent 403a may support more than one request information schema. Thus, a communications agent may provide a user interface to receive valid request information for a number of respective schemas. Context menu UI element 614a, in FIG. 6A, illustrates contactees. Any contactee may provide access to a service application via a communications agent representing the contactee. An input from a user corresponding to a communicant represented by an access communications agent, such as “jill@companyB.com” context menu item 614a, corresponds to a communicant identifier of an access user via which a service application may be accessed to perform the request identified by request information. A schema for a request may be identified based on a contactee address.

FIG. 6A illustrates a request information UI element integrated with a user interface presented to interact with a user to generate and/or otherwise edit a communicant message. Alternatively or additionally, a communications agent may provide a request information UI element integrated in to a main window presented by the communications agent and/or may present a request information UI element in a tab and/or in a dialog box.

FIG. 6B illustrates an arrangement of UI elements some or all of which that may be presented as a dialog box, in a tab, and/or in main window of communications agent 403a in FIG. 4A. As with FIG. 6A, a UI element handler component 421a may operate to present a request information UI element 630b, illustrated in FIG. 6B, in request window UI element 602b. The same or different UI element handler component 421a may present various other UI elements included in request information UI element 630b. Request information UI element 630b and one or more UI elements it includes may be presented by one or more corresponding UI element handler component(s) 421a that may operate based on a schema that defines valid request information to create a communications request by communications agent 403a.

Search textbox UI element 632b allows a communications agent interacting with a user to receive input identifying a URI or a portion thereof. When a portion of URI is identified, a complete URI may be generated based on the contactee identified by the communicant identifier in the contactee UI element 606b. In an aspect, a URI may be included in a previously received communicant message. Request information may be received by a content handler component 419a in FIG. 4A detecting a selection of a link, based on the URI, in the communicant message. The detecting may include presenting the link via a UI element handler component 422a and receiving input formation for an input detected by an input device. The input may correspond to the presented link. For example, a user may interact with a communications agent 403a including the UI element handler component by touching the link presented via a touch sensitive display device. The link may be presented in a communicant message received in the communication.

A communicant identifier for a contactee may be entered by the user or determined automatically based on the URI and/or based on a request specified according to some other schema. In an aspect, UI element 602b may be presented in response to a user input corresponding to another presented communication or portion thereof. A contactee address may be automatically determined based on the associated communication. A contactee communicant identifier may be based on a type of request identified by request information. Exemplary types of requests include a search request, a service access request, a data access request, a data submit request, a create request, a delete request, and a change request—too name a few examples. A request may have one or more type.

A communicant identifier identifying an access communicant may be identified based on a service application and/or based on received request information. In FIG. 6B, “amazon” is identified as identifier of a service application along with an identifier of a request type, “checkout”. A mapping may be accessed from a data store. The mapping may associate the request type and/or a service application with a communicant identifiers. For example, a child may associate a service application with a communicant identifier of a parent and/or other adult who may send the request to the service application on behalf of the child. In FIG. 6B, “amazon” and/or the “checkout” request type may be associated with the communicant identifier zack.zacks@nc.rr.com, which may identify a parent of the contactor. The parent may pay for the items in a shopping cart which is associated with one or both of the contactor and the access communicant by the service application provided by “Amazon”.

In an aspect, a request agent component 402a, in FIG. 4A, may interoperate with an address book manager (not shown) to identify an access communicant identifier based on a service application. The address book manager and/or any other data store manager suitable for maintaining data that associates a service application with a communicant identifier may be included in a requesting execution environment 401a. One more communicant identifier may be associated with a service application and/or a request. A communicant identifier in such an association may be in an address space of a communications protocol via which the communications request is sent. A communicant identifier in such an association may be in an address space of a communications protocol other than the communications protocol via which the communications request is sent. For example, a service application may be associated with a phone number. A user may communicate via voice with an access communicant and, in the same and/or different communication session, an IM and/or an email may be sent that includes a communications request.

As described, service textbox UI element 632b illustrates a textbox allowing a user to identify a service application, service application type, and/or other service application attribute. The service application may be identified by protocol address, a domain name, and/or by an alias as illustrated in FIG. 6B. Request textbox UI element 634b illustrates a textbox allowing a user to identify a resource accessible via the service application. The resource may be a data entity and/or an executable entity. The resource may be service, a data object stored by the service, and/or data object retrieved from the service in response to the request. For example, response data received in response to a service request may be and/or may otherwise identify the resource.

A save button UI element 636b may be provided to receive input information from a user instructing request agent 402a to save request information received via request information UI element 630b. A favorites list may be created via this means. A saved button UI element 638b may be provided to receive input information from a user instructing request agent 402a to retrieve one or more saved requests. Selection information may be received by request agent 402a that identifies a saved request to fill in data in request information UI element 630b for the user. Receiving request information may include receiving an input from the first user identifying an item, in a favorites list, including previously saved favorite information that identifies the first request. In another aspect, a history of communications requests may be maintained by communications agent. The history may be presented to a user allowing the user to save requests as favorites and/or otherwise reuse previously sent communications requests.

FIG. 7 illustrates a construct request dataflow 704 that may be a dataflow internal to requesting execution environment 401a in FIG. 4A and/or may include receiving data via network 508 by requesting execution environment 401a. Request information dataflow 704, in FIG. 7, may represent an exchange of request information and/or information based on request information received by and/or otherwise identified to a UI element handler component 421a interoperating with request agent component 402a, in FIG. 4A. A construct request dataflow may be and/or may occur in response to a user input, detected by communications agent 403a. The user input may be specified to identify a command to send a communications request based on received request information in a request information dataflow. In another aspect, a construct request dataflow may include an exchange of request information and/or information based on request information received by content manager component 415a and provided to request agent component 402a, via network 508 from, for example, a browser operating as a user agent in a node (not shown) in network 508

A request agent component may be a type of content handler component that operates to process request information to create a communications request that conforms to a schema to create and/or otherwise to construct a valid communications request. A request agent component may construct from and/or otherwise transform request information into a communications request based on a schema that defines and/or otherwise identifies a valid communications request for a particular type of data unit, message, and/or communication supported by a communications agent. Request agent component 402a, operating in requesting execution environment 401a of requesting node 502, may provide the communications request to content manager component 415a to include and/or otherwise identify the communications request in a message and/or data unit of a communications protocol in a communication with an access communications agent 405b.

As described above, content manager component 415a, in FIG. 4A, may operate in requesting execution environment 401a to transform request information into a communications request to include along with data for other parts of a communication into one or more data representations suitable for transmitting in the communication to another node, such as access execution environment 401b of access node 504. Some or all of the data representations transmitted are suitable for processing by a receiving access communications agent 405b. Content manager component 415a in the requesting execution environment 401a may package the one or more data representations including a representation of the communications request into a message and/or data unit according to the communications protocol.

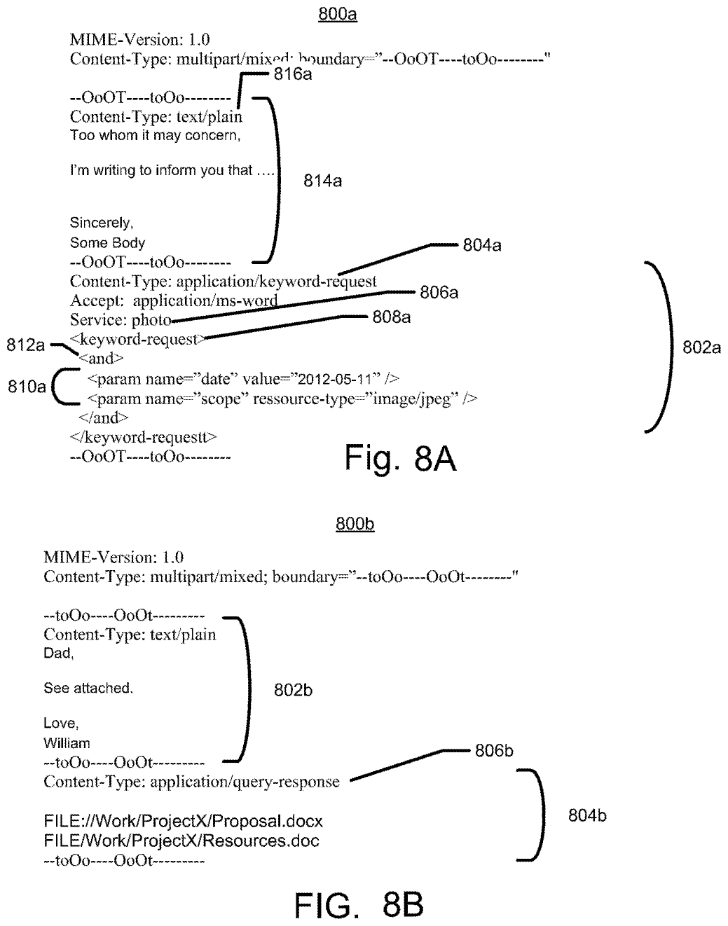

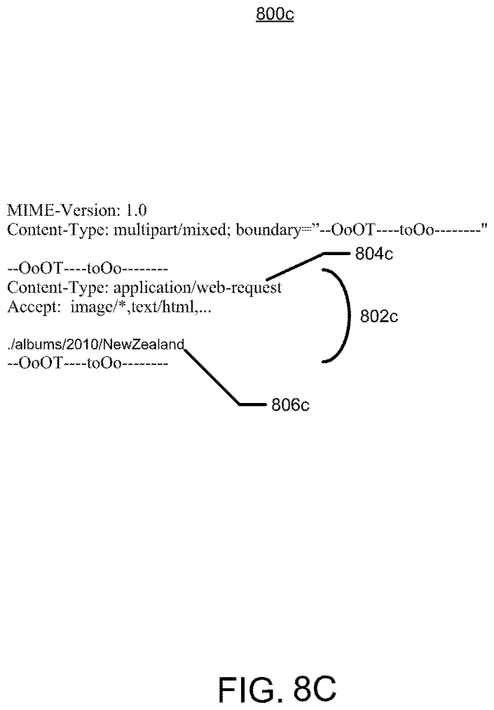

In FIG. 8A, a portion of an email communication 800a is illustrated formatted as a multipart/mixed content type including communications request portion 802a. A communications request portion of a communication may be identified as a communications request by its location in the communication and/or by an identifier or markup element, such as a MIME type identifier. A communications request may be detected based on content included in the communication and/or based on metadata such as content-type header 804a identifying a MIME type identifier, such as “application/keyword-request”, which may be defined to represent one or more keywords, reserved and/or unreserved, in a request expression in a communication that identifies a particular type of communications request. The “application/keyword-request” MIME type identifier is exemplary. Other MIME type identifiers exist and/or may be defined to identify a communications request in a communication.

In an aspect, a service application may be identified in the communications request. For example, a service header 806a in communications request portion 802a may be defined for identifying one or more of a service application, a network protocol address of a service application, an alias for a type of service applications, and/or a domain for a service application. Service header 806a identifies “photo” as a service type identifying a digital photography service in FIG. 8A. A receiving access communications agent may identify a service application automatically or via interaction with a user, as described below in more detail.

A request agent component 402a and/or a content manager component 415a, in FIG. 4A, may operate to construct a communications request in a message and/or a data unit of a communications protocol. A content type identifier may be included in a position and/or location that identifies a communications request in a communication. The position or location may be absolute or relative. For example, a schema for a communication may define that a communications request in a communication is included in the communication at the end of the communication. There may be one or more communications requests at the end. In another aspect, a schema for a communication may specify that a portion of a communication following a particular message portion is a communications request. Other communications requests of one or more types may follow. If no communications request is included, the communications request portion may include no content, may include an indicator that no communications request is included, or may be absent.

FIG. 8A illustrates an “application/keyword-request” MIME type identifier that may be defined to identify a schema for an XML-based language for specifying keyword-request XML documents. FIG. 8A illustrates keyword-request document 808a. Keyword-request document 808a, as illustrated, includes param tag elements 810a corresponding to one more request parameters, such as illustrated in FIG. 6A. A param tag element 810a may identify a request parameter by name, such as “date”. Alternatively or additionally, a parameter may be identified by its location and/or relative order. The param tag element 810a identifies a value for a date parameter for the photo service. The request may be for photographs captured on the date stored by a photo-service with which an access communicant maintains an account. Another param tag element 810a specifies a scope for resource types identifying that only JPEG images should be identified in a response to the search. FIG. 8A illustrates an “and” tag 812a indicating that all the matching criteria must be met to identify a resource. An “or” tag (not shown) may be defined by a schema for keyword-request documents. Other operator elements and operator precedence may be defined by the schema. Grouping elements, such as a parenthesis element, to manage operator precedence may be defined by the schema.

In FIG. 8C, a portion of a communication 800c is illustrated formatted as a multipart/mixed content type or a portion thereof including communications request portion 802c. The communications request may be detected based on a content-type header 804c identifying a MIME type identifier, such as “application/web-request”, which may be defined to identify a HTTP URL 806c or a portion of a HTTP URL identifying a request with respect to a receiving access communications agent.

With reference to FIG. 2A, a block 204 illustrates that the method includes sending, in a communication via a network by the first communications agent to a second communications agent in a second execution environment representing a second user, a communications request based on the request information. Accordingly, a system for accessing a service via a proxy communications agent includes means for sending, in a communication via a network by the first communications agent to a second communications agent in a second execution environment representing a second user, a communications request based on the request information. For example, the arrangement in FIG. 3A, includes com-out component 304 that is operable for and/or otherwise included in sending, in a communication via a network by the first communications agent to a second communications agent in a second execution environment representing a second user, a communications request based on the request information. FIG. 4A-B illustrate com-out components 404 as adaptations and/or analogs of the com-out component 304 in FIG. 3A. One or more com-out components 404 operate in an execution environment 401. A system for accessing a service via a proxy communications agent includes one or more processors and logic encoded in one or more computer readable media for execution by the one or more processors that when executed is operable for and/or otherwise included in sending, in a communication via a network by the first communications agent to a second communications agent in a second execution environment representing a second user, a communications request based on the request information.

FIG. 7 illustrates a communications request dataflow 706 that may include transmitting a data unit and/or message of a communications protocol. The data unit and/or message may be sent via the communications protocol from communications agent 403a operating in requesting execution environment 401a in FIG. 4A via network 508 and received by access communications agent 405b operating in requesting execution environment 401b in FIG. 4B.

A communications request may be sent to an access communications agent for any number of reasons. For example, a service application may be inaccessible to a user agent, but accessible via a communications agent. Alternatively or additionally, a first service application may not accessible to perform a particular request when received from a particular execution environment and/or node, such as requesting execution environment 401a and/or requesting node 502. For example, information required to access service application 409c of service node 506 may not be accessible to requesting execution environment 401a and/or a user of requesting execution environment 401a. An execution environment hosting a service application and/or the service application may not be enabled to authenticate the user of requesting execution environment 401a and/or requesting node 502. An execution environment hosting a service application and/or the service application may not be enabled to authorize a particular request or any request received from requesting execution environment 401a and/or requesting node 502.

In an aspect, a firewall may block access to service application 409c by requesting execution environment 401a of requesting node 502. Access execution environment 405b may include a communications protocol endpoint accessible to requesting execution environment 401a and access execution environment 405b may include a protocol endpoint communicatively coupling access execution environment 401b to service execution environment 401c. In yet another aspect, service application 409c may be communicatively coupled to one or more nodes in network 508 via a network protocol not supported by requesting execution environment 401a and/or by particular applications operating in requesting execution environment 401a. Service execution environment 401c may not be enabled to authenticate and/or to authorize one or more particular requests when received from requesting execution environment 401a, requesting communications agent 403a, and/or a user represented by one or both of requesting execution environment 401a and requesting communications agent 403a. A network protocol address identifying a network interface of requesting execution environment 401a may not be allowed to send any service request and/or a particular service request that is addressed to a network protocol address that identifies a network interface of the service execution environment. A service request from requesting execution environment 401a addressed to service execution environment 401c and/or a service application operating in service execution environment 401c may be blocked based on a time, a location, and/or type of request—too name a few other examples.

FIG. 4B, illustrates access communications agent 405b operating in access execution environment 401b of access node 504 in FIG. 5. Com-out component 404a in requesting execution environment 401a may send a communications request to access communications agent 405b operating in an access execution environment 401b. Access communications agent 405b may receive the communications request via com-in component 417b, as described above.

A communications request generated by request agent component 402a, in FIG. 4A, along with a communicant message and any other data that may be included in a communications request dataflow 706, may be provided and/or otherwise identified to content manager component 415a to send via com-out component 404a. Content manager component 415a in requesting execution environment 401a of requesting node 502 may package the one or more representations including a representation of the communications request into a communication formatted according to the communications protocol. Com-out component 404a may provide the communications request, a communicant message, and any other data to send in a communication in data representations suitable to send by communications protocol component 413a to a communications agent, such as access communications agent 405b in access execution environment 401b of access node 504.

Content manager component 415a and/or com-out component 404a, in FIG. 4A, may alternatively or additionally encode and/or otherwise transform one or more of the data representations to send in a data stream such as voice stream and/or a video stream to communicate in a communication with components of access communications agent 405b in access execution environment 401b.

In an aspect, a communications request may be sent in a communication along with a communicant message addressed with a contactee communicant identifier that identifies a communication represented by a communications agent. A communications request may be included in a communicant message. For example, a URI or a portion thereof and/or a search query may be included in a communicant message as a communications request. The contactee communicant identifier may be in an address space of a communications protocol via which data is exchanged in the communication. The contactee communicant identifier may identify a communicant represented by a receiving access communications agent. For example, requesting communications agent 401a may send a communications request in communication via network 508 addressed to a user represented by access communications agent 405b in access execution environment 401b. The communication and the communications request may be addressed with communicant identifier of more than one communicant.

In an aspect, the communicant identifier of one or more recipients of a communications request may be included in authenticating and/or authorizing a request for processing by an access communications agent and/or a service application. The various addresses may be included in various address spaces of various communications protocols. For example, a phone number of one communicant may be included along with an email address identifying a communicant of an access communications agent.

In another aspect, sending a communications request by a requesting communications agent may include identifying multiple communicant identifier each identifying a respective contactee in the communication. Each contactee, in the aspect, may be represented by an access communications agent. The communications request may be sent to access communications agents that respectively represent contactees identified in the communication. The access communications agents may each separately process a request identified in the communications request and/or two or more access communications agents may cooperate in interacting with each other and/or with a service application in processing the request.

With reference to FIG. 2A, a block 206 illustrates that the method includes receiving, via the network by the first execution environment in response to sending the communications request, a communications response based on a first service response generated by a first service application included in processing the first service request. Accordingly, a system for accessing a service via a proxy communications agent includes means for receiving, via the network by the first execution environment in response to sending the communications request, a communications response based on a first service response generated by a first service application included in processing the first service request. For example, the arrangement in FIG. 3A, includes response director component 306 that is operable for and/or otherwise included in receiving, via the network by the first execution environment in response to sending the communications request, a communications response based on a first service response generated by a first service application included in processing the first service request. FIG. 4A illustrate a response director components 406a as an adaptation and/or analog of the response director component 306 in FIG. 3A. One or more response director components 406 operate in an execution environment 401. A system for accessing a service via a proxy communications agent includes one or more processors and logic encoded in one or more computer readable media for execution by the one or more processors that when executed is operable for and/or otherwise included in receiving, via the network by the first execution environment in response to sending the communications request, a communications response based on a first service response generated by a first service application included in processing the first service request.

FIG. 7 illustrates a communications response dataflow 708 that may include a data exchange via network 508 between access communications agent 405b in FIG. 4B and a requesting execution environment 401a. The exchange may include an exchange between response gateway component 420b in access execution environment 401b and a response director component 406a in requesting execution environment 401a. A communications response dataflow may include an exchange via a web protocol and/or via a communications protocol.

Receiving a communications response may include receiving the communications response from an access communications agent. The communications request that corresponds to the communications response may have been sent to the access communications agent sending the communications response and/or to another access communications agent. A communications response may be received from an access communications agent based on a service response and/or other message from a service application that processed a service request based on the communications request. The communications response may be received via a web protocol. The communications response may be received via a communications protocol. In FIG. 4A, response director component 406a may receive a communications response, from response gateway component 420b in access communications agent 405b in FIG. 4B, via communications protocol component 413a addressed to the requesting communicant represented by communications agent 403a.

A requesting communications agent may receive a communications response along with a communicant message addressed with a communicant identifier that identifies the requesting communicant represented by the requesting communications agent. The communications response and the communicant message may be received via a communications protocol by the requesting communications agent. The communications protocol may be the communications protocol via which the corresponding search was sent by requesting communications agent 403a representing the requesting communicant. In an aspect, the communicant identifier may be in an address space of another protocol. The communicant identifier may identify the requesting communicant. The communications response may be received via the same or a different communications protocol via which the communications request was sent.

In another aspect, a communications response to a communications request may be received by a requesting communications agent from a service application. The communications response received from the service application may be received via a web protocol, a communications protocol, and/or any other suitable network protocol. In FIG. 4A, response director component 406a in requesting execution environment 401a may receive a communications response from communications relay gateway component 459c transmitted via network 508. Response director component 406a may receive the communications response via web protocol component 431a. In an aspect, a communications response may be received by user agent 407a via web protocol component 431a. The communications response may be received in a message sent asynchronously or may be received as a response to a request from user agent 407a. In another aspect, a communications response may be received by requesting communications agent 403a from communications relay component 459c via communications protocol component 413c in FIG. 4C and via communications protocol component 413a in FIG. 4A.

Receiving a communications response by a requesting communications agent may include receiving the communications response in a plurality of communications responses in response to sending a communications request to a plurality of respective communications agents representing a plurality of contactees identified by respective contactee communicant identifier included in the communication As described above, a communications request may be sent by a requesting communications agent to more than one service application through one or more access communications agents. Each communications response in the plurality of communications responses may be based on a service response generated by a respective service application in processing a service request based on the communications request.

A requesting communications agent may receive a single communications response based on multiple responses from respective service applications. Alternatively or additionally. each communications response in the plurality of communications responses may be based on a respective service response generated by a respective service application for each access communications agent in the plurality of communications agents. In another aspect, each response in the plurality of responses may be based on a respective response generated by a same service application for each communications agent in the plurality of access communications agents. That is, multiple access agents may access a same service application. The respective communications responses may differ based on the respective access communicant and/or access information of the respective access communicants accessible to the access communications agents representing the respective access communicants. In another aspect. each response in the plurality of responses may be generated by a respective service application in a plurality of service applications

Receiving a communications response may include receiving a plurality of communications responses in response to sending the communications request to a plurality of communications agents representing a plurality of contactees identified by respective contactee communicant identifier included in the communication. A requesting communications agent, in another aspect, may receive a separate communications response from respective service applications. The communications responses may be received in separate network communications and/or network messages. The communications response may be received from one or more access communications agent respectively providing access to the service applications.

A communications response may include and/or otherwise identify a response to the request identified in the communications request. In an aspect, a communications response may identify retrieval information for retrieving at least a portion of a response to a request identified in a communications response. Retrieval information may identify an access location to retrieve some or all of a response. Retrieval information may include a URL or other type of link as described above.

A response to a request identified in a communications request may be received by sending a retrieval request via a network based on the retrieval information. The response or a portion thereof may be received in response to sending the retrieval request. In response to receiving retrieval information a requesting communications agent 403a may send a retrieval request, based on the retrieval information to an access node identified by the access location. A retrieval response may be received that includes some or all of the response to the request identified in the communications request.

Receiving a communications response may include presenting a response identified in the communications response via an output device. Some or all of a response received by a requesting communications agent in a communications response may be presented via an output device. If a communicant message is received with a communications response, the communicant message may be presented to a user with or without presenting the communications response. In an aspect, a communications response may be presented by a user agent operation in a requesting execution environment 401a. The user agent 407a may receive the communications response and/or may interoperate with the requesting communications agent 403a which may receive the communications response.

With reference to FIG. 2B, a block 212 illustrates that the method includes receiving, via a network by a second communications agent representing a second user and operating in a second execution environment from a first communications agent representing a first user and operating in a first execution environment, a communications request. Accordingly, a system for accessing a service via a proxy communications agent includes means for receiving, via a network by a second communications agent representing a second user and operating in a second execution environment from a first communications agent representing a first user and operating in a first execution environment, a communications request. For example, the arrangement in FIG. 3B, includes request-in component 312 that is operable for and/or otherwise included in receiving, via a network by a second communications agent representing a second user and operating in a second execution environment from a first communications agent representing a first user and operating in a first execution environment, a communications request. FIG. 4B illustrates request-in component 412b as an adaptation and/or analog of request-in component 312 in FIG. 3B. One or more request-in components 412 operate in an execution environment 401. A system for accessing a service via a proxy communications agent includes one or more processors and logic encoded in one or more computer readable media for execution by the one or more processors that when executed is operable for and/or otherwise included in receiving, via a network by a second communications agent representing a second user and operating in a second execution environment from a first communications agent representing a first user and operating in a first execution environment, a communications request. In FIG. 4B, request-in component 412b is illustrated as a component of access communications agent 405b.

FIG. 7, as described above, illustrates communications request dataflow 706, including and/or otherwise identifying a communications request received via network 508 by a request-in component in an access communications agent. In FIG. 4B, a communications request dataflow may include a communications request received by request-in component 412b in access communications agent 405b in access execution environment 401b of access node 504 in FIG. 5. FIG. 7 illustrates a communications request dataflow 706 including data sent from requesting execution environment 401a. A communications request may be received by request-in component 412b, in FIG. 4B, via a network interface of access node 504 in FIG. 5.

A communications request dataflow may include receiving a communications request in one or more packets via network 508 by network stack 411b and data units of communications protocol component 413b in an instance of and/or analog of execution environment 401b, in FIG. 4B. Data in a communications request dataflow may be received by com-in component 417b. Com-in component 417b in access execution environment 401b may receive the communications request via communications protocol component 413b and network stack 411b. The communications request may be delivered to execution environment 401b of access node 504 via network 508 based on a communicant identifier represented by access communications agent 405b. Com-in component 417b may provide the data to content manager component 415b. Content manager component 415b may determine that the data identifies a request for a service application. For example, one or more content types of the data may indicate the data is a request for a service application as described above with respect to FIG. 8A and FIG. 8C. The content and/or portions of the content may be provided to request-in component 412b based on the one or more content types identified by content manager component 415b.

As described, content manager component 415b, in FIG. 4B may detect content type information to detect a communications request in a communication. For example, content manager component 415b may detect “application/web-request” MIME type identifier in content-type header 804c in FIG. 8C. The “application/web-request” MIME type identifier may be defined to identify a first request included in a communications request. Content manager component 415b may identify request portion 802c as including a first request, which identifies the communication as a communications request. In an aspect, request-in component 412b may be configured to operate according to a schema defining a format and/or a vocabulary for an XML-based language for keyword-request documents as illustrated in FIG. 8A. Content manager component 415b may provide keyword-request document 806a, as a request, to request-in component 412b. Request-in component 412b may operate according to the keyword-request schema. In an aspect, an access communications agent 405 may process more than one request content type. Alternatively or additionally, access execution environment 401b may include multiple request-in components 412b to support multiple communications request content types.

Content manager component 415b operating in access execution environment 401b may receive a data in a communication with requesting execution environment 401a. The data including a communications request may be delivered to execution environment 401b of access node 504 via network 508 based on a communicant identifier of a communicant represented by access communications agent 405b in access execution environment 401b of access node 504.

Receiving a communications request may include receiving the communications request in a communication along with a communicant message addressed with a contactee communicant identifier that identifies the communicant represented by the receiving communications agent. The communication message may be presented to the user via an output device. In FIG. 4B, one or more content handler components 419b included in processing a communicant message may interoperate with presentation controller component 423b to present a communicant message to a user via an display, audio device, and/or other output device. FIG. 8A illustrates communicant message portion 814a including “text/plain” MIME type identifier 816a as a content type identifier. Communicant message portion 814a may be provided to a text/plain content handler 419b. Audio data in a voice communication may be provided to an audio content handler component 419b, and video data in a video communication may be provided to a video content handler component 419b, some or all of which may be presented to a communicant identified as a contactee in the communication.

The communication may identify more than one communicant identifier. The communication may include a communicant identifier identifying the contactor and/or may include one or more communicant identifier that respectively identify other contactees. In an aspect, a request-in component 412b may operate to authenticate and/or authorize the request identified in the communications request based on one or more communicant identifier identified in the communications.

Exemplary resources that may be identified and/or requested via a communications request include a file, a program component, a data base record, video data, audio data, markup language, binary data, text data, an output of a service. Requested resources may be pre-existing, volatile, and/or generated in response to the request.

With reference to FIG. 2B, a block 214 illustrates that the method includes identifying access information, by the second communications agent based on the second user. Accordingly, a system for accessing a service via a proxy communications agent includes means for identifying access information, by the second communications agent based on the second user. For example, the arrangement in FIG. 3B, includes access proxy component 314 that is operable for and/or otherwise included in identifying access information, by the second communications agent based on the second user. FIG. 4B illustrates access proxy component 414b as an adaptation and/or analog of access proxy component 314 in FIG. 3B. One or more access proxy components 414 operate in an execution environment 401. A system for accessing a service via a proxy communications agent includes one or more processors and logic encoded in one or more computer readable media for execution by the one or more processors that when executed is operable for and/or otherwise included in identifying access information, by the second communications agent based on the second user. In FIG. 4B, access proxy component 414b is illustrated as a component of access communications agent 405b.

FIG. 7 illustrates an access information (AccessInfo) dataflow 710 that may be a data exchange internal to access execution environment 401b in FIG. 4B. An access information dataflow response dataflow may include an exchange between request-in component 412b and an access proxy component 414b in access execution environment 401b. An access information dataflow may include an exchange via network 508 between access execution environment 401b and another execution environment.

Identifying access information may include determining a service application in response to receiving a communications request. Access proxy component 414b may detect a service type, as illustrated in FIG. 6A and in FIG. 8A. Access proxy component 414b may identify a mapping and/or association between the service type, such as “Photos”, and a service application, such as photo sharing service. Access proxy component 414b may detect account information, as access information. The account information may identify an account with the identified service application. The account may be an account of the user represented by access communications agent 405b and/or access execution environment 401b. Access information may include and/or otherwise may be determined based on the account information.

Access information may be identified and/or otherwise determined based on one or more communicant identifier identified in the communication. In FIG. 6B, access information to complete a checkout at Amazon may require identification of a cart owner and a payer. In FIG. 4B, access proxy component 414b may locate cart owner information based on a communicant identifier of the contactor and may locate payer information based on a specified relationship between the communicant represented by access communications agent 405b and the contactor. For example, when the contactor is a child of access communicant, a personal credit card and/or bank account may be identified in payer information. When the contactor is an employee of the access communicant, a business credit card and/or bank account may be identified in the payer information.

Access information is and/or otherwise determined based on a type of request identified in a communications request. In FIG. 6B, the request is identified as a “checkout” type request. Access proxy component 414b may determine that access information includes and/or identifies a type of network protocol for communicating with the identified service. The type of network protocol may indicate whether the network protocol is an encrypted or unencrypted protocol. Access information may identify any suitable attribute of a network protocol included in exchanging data with a service application; such as network address, a port number, and the like.

Access information may be identified and/or otherwise determined based on a network address of the first execution environment, the access execution environment, the service execution environment, a location of the requesting user and/or other person, and/or a location associated with the service application—too name a few additional examples of information an access proxy component may process in identifying access information.

In some aspects, a communications request may be received and processed by an access communications agent, automatically, without interaction between the access communicant represented by the access communications agent 405b. In other aspects, interaction with the access communicant may be included in processing a communications request. For example, sensitive data such as a password may not be stored by access execution environment 401b. In identifying access information for a communications request, access proxy component 414b may interoperate with presentation controller component 423b to present a UI element prompting the access communicant to enter, via an input device, a password for a particular request identified in the communications request. An access communicant agent 405b may interact with a user to receive any access information that is not otherwise accessible via access execution environment and/or that otherwise requires interaction based on a specified process and/or policy for processing a communications request.

Identifying access information may include identifying an address of a service application. In an aspect, a template may be used to map information in a communications request to a network protocol address of a service application. For example, with respect to FIG. 6A, a request type may be mapped to a URL or a portion URL such as path and/or query portion. In another aspect, a service alias may be mapped to an Internet Protocol (IP) address, a type of protocol (e.g. FTP, HTTP, SSH, etc.), and/or a parameter to be included in an exchange of data with a service application. A template may, for example, be specified by a service application, a standards organization, and/or by a communicant included in processing a communications request.

Which service application to contact to process a request identified in a communications request may be identified in access information. A service application may be identified based on a communicant identifier of a communicant identified in the communication in which the communications request is sent. For example, a communications request may be included in an email and/or an instant message addressed to a communicant represented by a communications agent including and/or otherwise interoperating with an access communications agent 405. A communications request may be sent to one or more service application by an access communications agent and/or may be sent to more than one access communications agents that interoperate with respective service applications.

With reference to FIG. 2B, a block 216 illustrates that the method includes sending, via a network by the second execution environment in processing the communications request, a first service request along with the access information to a first service application. Accordingly, a system for accessing a service via a proxy communications agent includes means for sending, via a network by the second execution environment in processing the communications request, a first service request along with the access information to a first service application. For example, the arrangement in FIG. 3B, includes request gateway component 316 that is operable for and/or otherwise included in sending, via a network by the second execution environment in processing the communications request, a first service request along with the access information to a first service application. FIG. 4B illustrates request gateway component 416b as an adaptation and/or analog of request gateway component 316 in FIG. 3B. One or more request gateway components 416 operate in an execution environment 401. A system for accessing a service via a proxy communications agent includes one or more processors and logic encoded in one or more computer readable media for execution by the one or more processors that when executed is operable for and/or otherwise included in sending, via a network by the second execution environment in processing the communications request, a first service request along with the access information to a first service application. In FIG. 4B, request gateway component 416b is illustrated as a component of access communications agent 405b.

FIG. 7 illustrates a service request dataflow 712 that may include an exchange of data between an access communications agent 405 and a service application 409. A service request dataflow may include an exchange of data within an execution environment and/or between execution environments in various aspects. A service request may be sent automatically by an access execution environment 401b without interaction between the access execution environment 401b and a user in response to receiving the communications request

Sending a service request may include determining, based on a communications request, a network protocol for sending the service request to a service application. The network protocol may be a web protocol and the service request may be a web request. Access communications agent 405b, in FIG. 4B, may receive, via a network interface of access node 504, a communications request from requesting communications agent 403a, via a network interface of requesting node 502. An access communications agent 405b may send a web request to service application 409c, in FIG. 4C, via a network interface of service node 506. In an aspect, a web request may be exchanged in an execution environment that hosts some or all of an access communications agent 405 and some or all of a service application 409.

In FIG. 4B, request gateway component 416b may transform a communications request to transmit a service request as a web request via a web protocol. Request gateway component 416b may interoperate with web protocol component 431b to transmit a service request as and/or otherwise included in a web request via a network. The web request may be received via application server 435c via web protocol component 431c in service execution environment. Application server 435c may provide and/or otherwise identify a command based on the service request to a request handler component 439c in controller component 437c for routing within service application 409c. Request gateway component 416b may send a service request, for example, in a HTTP request via web protocol component 435b.

In another aspect, a service request may be and/or otherwise may be included in a communications request sent to a service application. Request gateway 416b, in FIG. 4B, may transform and/or otherwise process a communications request to transmit a service request via a communications protocol. The communications protocol may be the same or different communications protocol by which access communications agent 405b received the communications request. The communications request, suitably represented for transmission via the communications protocol, may be sent by communications protocol component 413b via a network and received via communications protocol component 413c in service execution environment 401c. For example, a service request may be sent via an email protocol such as version of a SMTP and/or a POP protocol. The communications request may be received by a communication relay component 459c. The communications request may be forwarded to a suitable command handler component 443c directly. In another aspect, a communications request may be forwarded to command handler component 443c indirectly. For example, a communications request received via communications protocol component 413c may be routed to a request handler component 439c by communications relay component 459c. A request handler component 439c may receive a communications request as a web request from communication relay component 459c. A request handler component 457c may include instructions that when executed process a communications request received via communications relay component 459c.

FIG. 7 illustrates a service dataflow 714 that may include a dataflow internal to service execution environment 401c in FIG. 4C. In an aspect, a service dataflow may include an exchange of data between command handler component 443c and one or more components included in processing a particular request. A service dataflow may include an exchange of data between service application 409c and another node (not shown), in other aspects.

Generating a communications response may include receiving a service response, from a service application included in generating and/or otherwise receiving a communications response, by an access communications agent. FIG. 7 illustrates a service response dataflow 716 that may be a data exchange via network 508 between service application 409c in FIG. 4C and access communications agent 405b in FIG. 4B. A service response dataflow may include an exchange between response handler component 457c in service execution environment 401c and a response-in component 418b in access execution environment 401b. A service response dataflow may include an exchange via a web protocol, a communications protocol, and/or some other type of network protocol.

A communications response based on a service response to a service request via an access communications agent may identify a resource not identified in service response to a service request made directly be a requesting user agent without an access communications agent operating as a proxy in relaying the corresponding request. A service response made directly may identify a resource not identified by a communications response for a communication sent via an access communications agent.

In an aspect, an access communications agent may send a service request identified based on a received communications request to multiple service applications. Access information identified by an access proxy component 414b may identify more than one service application. Access proxy component 414b may interoperate with request gateway component 416b to send a service request to each of several service applications and/or may send a service request via a broadcast. A response-in component 418b may receive multiple service responses from the various service applications. Response-in component 418b may provide the service responses and/or information based on the service responses to a response gateway component 420b included in generating a communications response, as described below.

FIG. 7 illustrates generate response (GenResp) dataflow 718 which may include a dataflow internal to service execution environment 401c in FIG. 4C and/or may include a dataflow internal to access execution environment 401b in FIG. 4B. A generate response dataflow may include an exchange of data between a response-in component 418b and a response gateway component 420b in access execution environment 401b.

In FIG. 4C, response handler component 457c may identify and/or otherwise send a service response to response-in component 418b in FIG. 4B via network 508. Response-in component 418b may perform any filtering, sorting, and/or formatting of data received in the service request that was not performed by response handler 457c. Service applications may vary in such functionality. Further response-in component 418b may prepare information received from response handler component 457c to identify to response gateway component 420b whether to use a web protocol or a communications protocol to send a communications response identifying some or all of the data received in a service response.

A service response may be exchanged via a network between an access execution environment that hosts some or all of an access communications agent and a service execution environment that hosts some or all of a service application. The service response may be exchanged via a communications protocol. The service response may be exchanged via a web protocol. The exchange may occur between response handler component 457c and/or communications relay component 459c in service execution environment 401c and response-in component 418b in access execution environment 401b. Additional service applications 409 in other execution environments of the same service provider 508 may send respective service responses to response-in component 418b in access execution environment 401b. Response-in component 418b may build a communications response based on one or more service responses from one or more service applications 409.

FIG. 7 illustrates communications response dataflow 708, described above, that may include a data exchange via network 508 between access communications agent 405b in FIG. 4B and a requesting execution environment 401a. The exchange may include an exchange between response gateway component 420b in access execution environment 401b and a response director component 406a in requesting execution environment 401a. A communications response may be sent via a web protocol, a communications protocol, and/or via any other suitable network protocol.

In FIG. 4B, response gateway component 420b may send a communications response via communications protocol component 413b addressed to the requesting communicant represented by communications agent 403a in requesting execution environment 401a. A communications response may be received by communications agent 403a via communications protocol component 413a in requesting execution environment 401a as described in the previous paragraph.

Sending a communications response may include sending the communications response in a communication along with a communicant message addressed with a communicant identifier of the requesting communicant. The communicant identifier may be included in an address space of a communications protocol. The communications protocol may be the communications protocol via which the corresponding communications request was sent by a communications agent representing the requesting communicant. In an aspect, the communicant identifier may be in an address space of another protocol. The communicant identifier may identify the requesting communicant. The communications response may be received via the same or a different communications protocol by which the communications request was sent. In some aspects, an access communications agent may operate automatically in response to receiving a service response from a service request to send a communications response. In other aspects, a response gateway component 420b may detect that additional information is required and/or otherwise identified as available from a user of access execution environment. Response gateway component 420b may interoperate with presentation controller 423b to present a user interface to interact with the user to receive any such additional information.

In another aspect, a communicant may be identified as copied in a communication as in a letter and/or in an email. Such communicants are referred to herein as CC communicants and communications agents that represent CC communicants are referred to herein as CC communications agents. Sending a communications request in a communication may include identifying in the communication a CC communicant identifier identifying a CC communicant in the communication to indicate a communications response based on the first response is to be sent to a communications agent representing the CC communicant. A copied communicant may be an access communicant and may process a communications request as an access communications agent. In an aspect, a CC communications agent may process a communications request as an access communications agent based on an access communications agent and/or an access communicant identified in the communications. For example, a CC communications agent may process a communications request when the CC communications agent receives information indicating the access communications agent is unable and/or impaired in its ability to process the communications request. The information may be received from a user, from the identified access communications agent, and/or based on not receiving a copy and/or other indication that a communications response has been sent to the requesting communicant. For example, a CC communications agent may operate as an access communications agent in response to detecting a timeout condition.

An access communications agent 405b may detect a CC communicant identifier and send a copy and/or other indication that the communications request has been and/or will be processed. An access proxy component 414b may operate to correlate communications requests with communications responses for an access communications agent. A response gateway component 420b may interoperate with the access proxy component 414b to identify any CC communicants. An access communications agent may send an indication to a CC communications agent to process the communications request as an access communications agent. A condition under which a CC communications agent operates as an access communications agent may be determined based on input from a user, via interoperation of a communications agent with another communications agent, via interoperation of a service application, a communications agent, and/or via interoperation of a service application with another service application.

Receiving a communications request may include identifying in the communication a CC communicant identifier identifying a CC communicant in the communication, and sending a communications to a communications agent representing the CC based on a service response and/or a lack on a service response communicant.

Performing the method illustrated in FIG. 2A-B and/or any of its extension and/or in any of its aspects may include one or more of calling a function or method of an object, sending a message via a network; sending a message via an inter-process communication mechanism such as a pipe, a semaphore, a shared data area, and/or a queue; and/or receiving a request such as poll and responding to invoke, and sending an asynchronous message.

To the accomplishment of the foregoing and related ends, the descriptions and annexed drawings set forth certain illustrative aspects and implementations of the disclosure. These are indicative of but a few of the various ways in which one or more aspects of the disclosure may be employed. The other aspects, advantages, and novel features of the disclosure will become apparent from the detailed description included herein when considered in conjunction with the annexed drawings.

It should be understood that the various components illustrated in the various block diagrams represent logical components that operate to perform the functionality described herein and may be implemented in software, hardware, or a combination of the two. Moreover, some or all of these logical components may be combined, some may be omitted altogether, and additional components may be added while still achieving the functionality described herein. Thus, the subject matter described herein may be embodied in many different variations, and all such variations are contemplated to be within the scope of what is claimed.

To facilitate an understanding of the subject matter described above, many aspects are described in terms of sequences of actions that may be performed by elements of a computer system. For example, it will be recognized that the various actions may be performed by specialized circuits or circuitry (e.g., discrete logic gates interconnected to perform a specialized function), by program instructions being executed by one or more processors, or by a combination of both. The description herein of any sequence of actions is not intended to imply that the specific order described for performing that sequence must be followed.

Moreover, the methods described herein may be embodied in executable instructions stored in a non-transitory computer readable medium for use by or in connection with an instruction execution machine, system, apparatus, or device, such as a computer-based or processor-containing machine, system, apparatus, or device. As used here, a “non-transitory computer readable medium” may include one or more of any suitable media for storing the executable instructions of a computer program in one or more forms including an electronic, magnetic, optical, and electromagnetic form, such that the instruction execution machine, system, apparatus, or device may read (or fetch) the instructions from the non-transitory computer readable medium and execute the instructions for carrying out the described methods. A non-transitory computer readable medium is non-transitory. A non-exhaustive list of conventional exemplary non-transitory computer readable media includes a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD.™.), and a Blu-ray.™. disc; and the like.

Thus, the subject matter described herein may be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents.

All methods described herein may be performed in any order unless otherwise indicated herein explicitly or by context. The use of the terms “a” and “an” and “the” and similar referents in the context of the foregoing description and in the context of the following claims are to be construed to include the singular and the plural, unless otherwise indicated herein explicitly or clearly contradicted by context. The foregoing description is not to be interpreted as indicating that any non-claimed element is essential to the practice of the subject matter as claimed.

I claim:

1. A method comprising:
receiving, via interaction with a first user by a first communications agent in a first execution environment, request information for identifying a first service request;
sending, in a communication via a network by the first communications agent to a second communications agent in a second execution environment representing a second user, a communications request based on the request information; and
receiving, via the network by the first execution environment in response to sending the communications request, a communications response based on a first service response generated by a first service application included in processing the first service request;
wherein performing at least one of the preceding actions comprising the method includes execution of an instruction by a processor.

2. The method of claim 1 wherein the method includes automatically identifying, based on the request information, a second communicant identifier that identifies the second user.

3. The method of claim 1 receiving request information may include receiving an input from the first user identifying an item, in a list of previously saved items, that identifies the request information.

4. The method of claim 1 wherein sending the communications request includes sending the communications request in the communication along with a communicant message addressed with a second communicant identifier that identifies the second user.

5. The method of claim 1 wherein sending the communications request includes:
identifying a first plurality of access communicant identifiers each identifying a respective contactee in the communication; and
sending the communications request to a plurality of access communications agents that respectively represent each contactee identified in the first plurality to process the first service request by at least the first service application.

6. The method of claim 1 wherein receiving the communications response includes receiving the communications response in a plurality of communications responses received in response to sending the communications request.

7. The method of claim 1 wherein receiving the communications response includes receiving the communications response along with a communicant message addressed with a first communicant identifier that identifies the first user

8. The method of claim 1 wherein the communications response is received by the first communications agent and the method further includes sending presentation information, based on the communications response, to a user agent operating in the first execution environment.

9. A method comprising:
receiving, via a network by a second communications agent representing a second user and operating in a second execution environment from a first communications agent representing a first user and operating in a first execution environment, a communications request;
identifying access information, by the second communications agent based on the second user; and
sending, via a network by the second execution environment in processing the communications request, a first service request along with the access information to a first service application,
wherein performing at least one of the preceding actions comprising the method includes execution of an instruction by a processor.

10. The method of claim 9 wherein receiving the communications request includes receiving the communications request in the communication along with a communicant message addressed to the second user by a second communicant identifier in the communication; and presenting the communicant message via an output device

11. The method of claim 9 wherein receiving the communications request includes:
receiving a second communicant identifier that identifies the second user and at least one other communicant identifier in the communication; and
performing, based on the second communicant identifier and the at least one other communicant identifier, at least one of an authentication operation and an authorization operation by the second execution environment in response to receiving the communications request.

12. The method of claim 9 wherein receiving the communications request includes:
identifying in the communication a CC communicant identifier identifying a CC communicant in the communication; and
sending, based on a first service response received in response to sending the first service request, a communication to a communications agent representing the CC communicant.

13. The method of claim 9 wherein identifying the access information includes:
detecting an account that the second user has with the first service application; and
identifying the access information based on the account

14. The method of claim 9 wherein the access information is identified based on at least one of a first communicant identifier that identifies the first user and a type of the communications request.

15. The method of claim 9 wherein sending the first service request includes:
sending a plurality of service requests to a respective plurality of service applications;
receiving a plurality of service responses in response to sending the respective plurality of service requests; and
sending a communications response based on the plurality of service responses.

16. The method of claim 9 further includes:
receiving a first service response in response to sending the first service request; and
sending a communications response, based on the first service response, to the first execution environment.

17. The method of claim 16 wherein sending the communications response includes sending the communications response along with a communicant message addressed with a first communicant identifier that identifies the first user.

18. A non-transitory computer readable medium embodying a computer program including instructions executable by a machine, for:
receiving, via a network by a second communications agent representing a second user and operating in a second execution environment from a first communications agent representing a first user and operating in a first execution environment, a communications request;
identifying access information, by the second communications agent based on the second user;
sending, via a network by the second execution environment in processing the communications request, a first service request along with the access information to a first service application.
